(19) United States
(12) Patent Application Publication
(10) Pub. No.: US 2025/0070492 A1
(43) Pub. Date: Feb. 27, 2025

(54) ELECTRICAL CONNECTOR SYSTEM

(71) Applicant: TE Connectivity Solutions GmbH, Schaffhausen (CH)

(72) Inventors: Brian Patrick Costello, Athens, GA (US); Chad William Morgan, Carneys Point, NJ (US); John Joseph Consoli, Harrisburg, PA (US); Christopher William Blackburn, Bothell, WA (US); Phillip Chang, Middletown, PA (US)

(21) Appl. No.: 18/644,337

(22) Filed: Apr. 24, 2024

Related U.S. Application Data
(60) Provisional application No. 63/520,683, filed on Aug. 21, 2023.

(51) Int. Cl. H01R 12/72; H01R 12/75; H01R 13/629; H01R 13/6581

(52) U.S. Cl. CPC H01R 12/722; H01R 12/75; H01R 13/629; H01R 13/6581

(57) ABSTRACT

An electrical connector system includes a circuit card assembly that includes a host circuit board, an interposer, and a socket connector arranged in a circuit stack. The electrical connector system includes a cable assembly that has cables electrically connected to terminating ends of the interposer contacts. The electrical connector system includes a pluggable module having a mating end with a module circuit board mated with the socket contacts of the socket connector. The electrical connector system includes a loading mechanism operably coupled to the circuit card assembly operated to compress the socket contacts between the module circuit board and interposer contacts to create circuit paths between the module contacts and the interposer contacts through the socket contacts. The cables are electrically connected to the pluggable module through the interposer and the socket connector.

### CROSS REFERENCE TO RELATED APPLICATIONS

This application claims benefit to U.S. Provisional Application No. 63/520,683, filed 21 Aug. 2023, titled “ELECTRICAL CONNECTOR SYSTEM”, the subject matter of which is herein incorporated by reference in its entirety.

### BACKGROUND OF THE INVENTION

The subject matter herein relates generally to electrical connector systems.

Some communication systems utilize communication connectors, such as card edge connectors to interconnect various components of the system for data communication. Some known communication systems use pluggable modules, such as I/O modules, that are electrically connected to the card edge connectors. The pluggable modules have module circuit boards having card edges that are mated with the card edge connectors during the mating operation. The module circuit boards are typically limited to two rows of contacts with a first row of the contacts on the upper surface of the module circuit board and with a second row of the contacts on the lower surface of the module circuit board. As such, the density of the communication system is limited by the mating interface defined by the card edge connector and the module circuit board. The card edge connectors are typically mounted to a circuit board and signal paths are routed through the circuit board to another electronic device, such as an integrated circuit. However, the systems are subject to signal degradation along the length of the traces between the card edge connectors and the integrated circuit, particularly at higher speeds.

A need remains for a high-speed communication system having high contact density.

### BRIEF DESCRIPTION OF THE INVENTION

In one embodiment, an electrical connector system is provided and includes a circuit card assembly that includes a host circuit board, an interposer, and a socket connector arranged in a circuit stack. The interposer includes interposer contacts. The interposer contacts have mating ends and terminating ends opposite the mating ends. The socket connector includes socket contacts. The socket contacts are compressible. The socket contacts have first mating ends and second mating ends. The first mating ends have separable mating interfaces. The second mating ends have separable mating interfaces. The second mating ends are connected to the mating ends of the corresponding interposer contacts. The electrical connector system includes a cable assembly that has cables electrically connected to corresponding terminating ends of the interposer contacts. The electrical connector system includes a pluggable module that includes a module body that has a top and a bottom. The pluggable module has a mating end. The pluggable module includes a module circuit board held by the module body at the mating end. The module circuit board has module contacts mated with the corresponding first mating ends of the socket contacts. The electrical connector system includes a loading mechanism operably coupled to the circuit card assembly. The loading mechanism is operated to compress the socket contacts between the module circuit board and the interposer contacts to create circuit paths between the module contacts and the interposer contacts through the socket contacts. The cables are electrically connected to the pluggable module through the interposer and the socket connector.

In another embodiment, an electrical connector system is provided and includes a circuit card assembly that includes a host circuit board, an interposer, and a socket connector arranged in a circuit stack. The interposer includes interposer contacts. The interposer contacts have mating ends and terminating ends opposite the mating ends. The socket connector includes socket contacts. The socket contacts are compressible. The socket contacts have first mating ends and second mating ends. The first mating ends have separable mating interfaces. The second mating ends have separable mating interfaces. The second mating ends are connected to the mating ends of the corresponding interposer contacts. The electrical connector system includes a pluggable module that includes a module body that has a top and a bottom. The pluggable module has a mating end. The pluggable module includes a module circuit board held by the module body at the mating end. The module circuit board has module contacts mated with the corresponding first mating ends of the socket contacts. The electrical connector system includes a loading mechanism operably coupled to the circuit card assembly. The loading mechanism is operated to compress the socket contacts between the module circuit board and the interposer contacts to create circuit paths between the module contacts and the interposer contacts through the socket contacts.

In a further embodiment, an electrical connector system is provided and includes a circuit card assembly that includes a host circuit board, a cage mounted to the host circuit board, a socket connector received in the cage, and an interposer received in the cage. The cage has shielding walls to form a module channel that extends between a front and a rear of the cage. The interposer includes interposer contacts. The interposer contacts have mating ends and terminating ends opposite the mating ends. The socket connector includes socket contacts. The socket contacts are compressible. The socket contacts have first mating ends and second mating ends. The first mating ends have separable mating interfaces. The second mating ends have separable mating interfaces. The second mating ends are connected to the mating ends of the corresponding interposer contacts. The electrical connector system includes a cable assembly that has cables electrically connected to corresponding terminating ends of the interposer contacts. The electrical connector system includes a pluggable module that includes a module body having a top and a bottom. The pluggable module has a mating end. The mating end of the pluggable module is loaded into the module channel in a module loading direction. The pluggable module includes a module circuit board held by the module body at the mating end. The module circuit board has module contacts mated with the corresponding first mating ends of the socket contacts. The pluggable module includes an actuation feature associated with the module body. The electrical connector system includes a loading mechanism operably coupled to the circuit card assembly. The loading mechanism engages the actuation feature of the pluggable module to force mating of the module contacts with the first mating ends of the socket contacts in a contact mating direction transverse to the module loading direction to compress the socket contacts between the module circuit board and the interposer contacts and create circuit paths between the module contacts and the interposer contacts through the socket contacts. The cables are electrically connected to the pluggable module through the interposer and the socket connector.

In another embodiment, an electrical connector system is provided and includes a circuit card assembly that includes a host circuit board, a socket connector mounted to the host circuit board, and a cage mounted to the host circuit board. The socket connector has a socket substrate having an upper contact array of upper contacts and a lower contact array of lower contacts electrically connected to corresponding upper contacts. The upper contacts having separable mating interfaces are accessible from above the socket connector. The cage has shielding walls to form a module channel with a port at a front of the cage to access the module channel. The socket connector is located in the module channel. The circuit card assembly includes a loading mechanism located in the module channel. The electrical connector system includes a pluggable module that includes a module body having a top and a bottom. The pluggable module has a mating end. The mating end of the pluggable module is loaded into the module channel through the port in a module loading direction. The module body has a window at the mating end along the bottom. The pluggable module includes a module circuit board held by the module body at the mating end. The module circuit board has a module contact array of module contacts aligned with the window. The module contacts are exposed from below the module body for mating with corresponding upper contacts of the circuit card assembly. The pluggable module includes an actuation feature associated with the module body to engage the loading mechanism of the circuit card assembly to force mating of the module contacts with the upper contacts of the circuit card assembly in a contact mating direction transverse to the module loading direction.

### BRIEF DESCRIPTION OF THE DRAWINGS

FIG. 1 is a front perspective view of an electrical connector system formed in accordance with an exemplary embodiment.

FIG. 2 is a bottom perspective view of the pluggable module in accordance with an exemplary embodiment.

FIG. 3 is a perspective view of the socket connector in accordance with an exemplary embodiment.

FIG. 4 is a perspective view of the interposer in accordance with an exemplary embodiment.

FIG. 5 is a front perspective view of the electrical connector system in accordance with an exemplary embodiment with various components removed to illustrate other components of the electrical connector system.

FIG. 6 is another front perspective view of the electrical connector system in accordance with an exemplary embodiment.

FIG. 7 is a perspective view of a portion of the electrical connector system showing the pluggable module and the interposer poised for coupling with the socket connector in accordance with an exemplary embodiment.

FIG. 8 is a perspective view of a portion of the electrical connector system showing the pluggable module and the interposer coupled to the socket connector in accordance with an exemplary embodiment.

FIG. 9 is a perspective view of the electrical connector system showing the pluggable module and the interposer plugged into the cage and showing the loading mechanism in an un-actuated position in accordance with an exemplary embodiment.

FIG. 10 is a perspective view of the electrical connector system showing the pluggable module and the interposer plugged into the cage and showing the loading mechanism in an actuated position in accordance with an exemplary embodiment.

FIG. 11 is a side view of the electrical connector system showing the pluggable module and the interposer plugged into the cage and showing the loading mechanism in an un-actuated position in accordance with an exemplary embodiment.

FIG. 12 is a side view of the electrical connector system showing the pluggable module and the interposer plugged into the cage and showing the loading mechanism in an actuated position in accordance with an exemplary embodiment.

FIG. 13 is a side view of the electrical connector system 100 showing the pluggable module, the socket connector, and the interposer in an unmated state in accordance with an exemplary embodiment.

FIG. 14 is a side view of the electrical connector system showing the pluggable module, the socket connector, and the interposer in a mated state in accordance with an exemplary embodiment.

FIG. 15 is a front perspective view of the electrical connector system showing the interposer in accordance with an exemplary embodiment poised for loading into the cage in accordance with an exemplary embodiment.

FIG. 16 is a front perspective view of the electrical connector system showing the interposer loaded into the cage in accordance with an exemplary embodiment.

FIG. 17 is a top perspective view of the interposer in accordance with an exemplary embodiment.

FIG. 18 is a bottom perspective view of the interposer in accordance with an exemplary embodiment.

FIG. 19 is a perspective view of a portion of the electrical connector system showing the pluggable module and the interposer poised for coupling with the socket connector in accordance with an exemplary embodiment.

FIG. 20 is a perspective view of a portion of the electrical connector system showing the pluggable module and the interposer coupled to the socket connector in accordance with an exemplary embodiment.

FIG. 21 is a perspective view of the electrical connector system showing the pluggable module and the interposer plugged into the cage and showing the loading mechanism in an un-actuated position in accordance with an exemplary embodiment.

FIG. 22 is a perspective view of the electrical connector system showing the pluggable module and the interposer plugged into the cage and showing the loading mechanism in an actuated position in accordance with an exemplary embodiment.

FIG. 23 is a side view of the electrical connector system showing the pluggable module, the socket connector, and the interposer in an unmated state in accordance with an exemplary embodiment.

FIG. 24 is a side view of the electrical connector system showing the pluggable module, the socket connector, and the interposer in a mated state in accordance with an exemplary embodiment.

FIG. 25 is a front perspective view of the electrical connector system 100 formed in accordance with an exemplary embodiment.

FIG. 26 is an exploded view of a portion of the electrical connector system in accordance with an exemplary embodiment.

FIG. 27 is a top perspective view of the socket connector in accordance with an exemplary embodiment.

FIG. 28 is a bottom perspective view of the socket connector in accordance with an exemplary embodiment.

FIG. 29 is a cross-sectional view of the socket connector in accordance with an exemplary embodiment.

FIG. 30 is a sectional view of the electrical connector system showing the pluggable module partially loaded into the cage in accordance with an exemplary embodiment.

FIG. 31 is a sectional view of the electrical connector system showing the pluggable module partially loaded into the cage and initially interfacing with the loading mechanism in accordance with an exemplary embodiment.

FIG. 32 is a sectional view of the electrical connector system showing the pluggable module fully loaded into the cage and mated with the socket connector in accordance with an exemplary embodiment.

FIG. 33 is a front perspective view of the electrical connector system formed in accordance with an exemplary embodiment.

FIG. 34 is an exploded view of a portion of the electrical connector system in accordance with an exemplary embodiment.

FIG. 35 is a top perspective view of a portion of the electrical connector system showing the socket connector and the interposer coupled to the host circuit board in accordance with an exemplary embodiment.

FIG. 36 is a bottom perspective view of a portion of the electrical connector system showing the socket connector and the interposer coupled to the host circuit board in accordance with an exemplary embodiment.

FIG. 37 is a bottom perspective, exploded view of a portion of the electrical connector system in accordance with an exemplary embodiment showing the socket connector, the interposer, and the components of the cable assembly.

FIG. 38 is a bottom perspective, assembled view of a portion of the electrical connector system in accordance with an exemplary embodiment showing the socket connector, the interposer, and the cable assembly.

FIG. 39 is a top perspective, assembled view of a portion of the electrical connector system in accordance with an exemplary embodiment showing the socket connector, the interposer, and the cable assembly.

FIG. 40 is a top perspective, exploded view of a portion of the electrical connector system in accordance with an exemplary embodiment.

FIG. 41 is a top perspective, exploded view of a portion of the electrical connector system in accordance with an exemplary embodiment showing the socket substrate poised for mating with the socket frame.

FIG. 42 is a top perspective, exploded view of a portion of the electrical connector system in accordance with an exemplary embodiment showing the socket substrate partially mated with the socket frame.

FIG. 43 is a sectional view of the electrical connector system showing the pluggable module partially loaded into the cage.

FIG. 44 is a sectional view of the electrical connector system showing the pluggable module partially loaded into the cage and initially interfacing with the loading mechanism.

FIG. 45 is a sectional view of the electrical connector system showing the pluggable module fully loaded into the cage and mated with the socket connector.

### DETAILED DESCRIPTION OF THE INVENTION

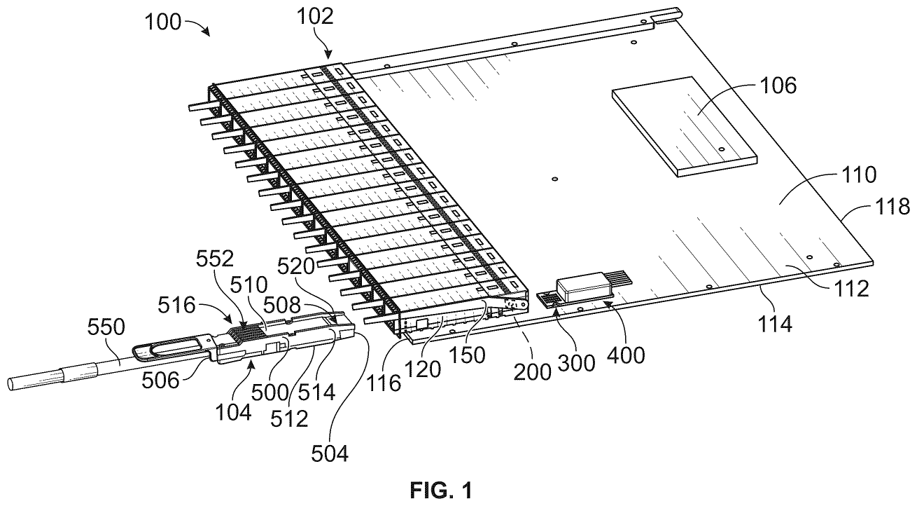

FIG. 1 is a front perspective view of an electrical connector system 100 formed in accordance with an exemplary embodiment. The electrical connector system 100 includes a circuit card assembly 102 and a pluggable module 104 mated with the circuit card assembly 102. Multiple circuit card assemblies 102 may be provided within the electrical connector system 100. In various embodiments, multiple pluggable modules 104 may be mated with the circuit card assembly 102. The pluggable modules 104 are removably coupled to the circuit card assembly 102. The pluggable modules 104 may be I/O modules forming part of a communication system. The circuit card assembly 102 of the communication system may be part of an end point device, a server or network switch, or another type of communication system.

In an exemplary embodiment, the circuit card assembly 102 includes a host circuit board 110, a cage 120, a socket connector 200 (shown in FIG. 3), an interposer 300, and a cable assembly 400. The cable assembly 400 is electrically connected to the pluggable module 104 through the interposer 300 and the socket connector 200. In an exemplary embodiment, the circuit card assembly 102 includes a loading mechanism 150 for electrically connecting the socket connector 200 with the pluggable module 104 and/or the interposer 300. For example, the loading mechanism 150 is configured to press contacts of the components together to create a reliable electrical connection. Optionally, the circuit card assembly 102 includes multiple socket connectors 200/interposers 300/cable assemblies 400 for interfacing with the corresponding pluggable modules 104. Optionally, the circuit card assembly 102 may include multiple cages 120 to accommodate the corresponding socket connectors 200 and interposers 300. The cage 120 is mounted to the host circuit board 110. The cage 120 provides shielding for the circuits (for example, the pluggable module 104 and/or the socket connector 200 and/or the interposer 300 and/or the cable assembly 400. In alternative embodiments, the circuit card assembly 102 may be used without the cage 120. In other alternative embodiments, the circuit card assembly 102 may be used without the cable assembly 400. For example, the interposer 300 may be directly electrically connected to the host circuit board 110 instead of routing the signals through the cable assembly 400.

The circuit card assembly 102 may be loaded into a rack or cabinet of a communication system, such as a rack or cabinet of a server or network switch. For example, the host circuit board 110 may be provided on a rack or tray at a bottom of the circuit card assembly 102. The host circuit board 110 includes an upper surface 112 and a lower surface 114. The host circuit board 110 includes a front edge 116. The cage 120 is coupled to the host circuit board 110 at the front edge 116. Optionally, multiple host circuit boards 110 may be arranged in the communication system. The circuit card assembly 102 may be coupled to a panel at a front of the circuit card assembly 102. In an exemplary embodiment, the system includes one or more electrical devices 106 on the host circuit board 110. For example, the electrical device 106 may be an integrated circuit, such as an IC chip mounted to the host circuit board 110. Other types of electrical devices may be mounted to the host circuit board 110, such as a processor, a memory module, or other type of electrical device. The electrical device 106 may be located proximate to a rear edge 118 of the host circuit board 110 in various embodiments. Alternately, the electrical device 106 may be located on another host circuit board.

In an exemplary embodiment, the pluggable modules 104 are electrically connected to the electrical device 106. For example, the pluggable modules 104 may be connected to the electrical device 106 through circuit traces on the host circuit board 110. In an exemplary embodiment, the pluggable modules 104 are connected to the electrical device 106 through the cable assemblies 400, such as through high speed cables, for improved signal performance (for example, reduced loss and/or cross talk). The cables of the cable assembly 400 are configured to be routed over the board to another component, such as an electrical connector, for connection to the electrical device 106.

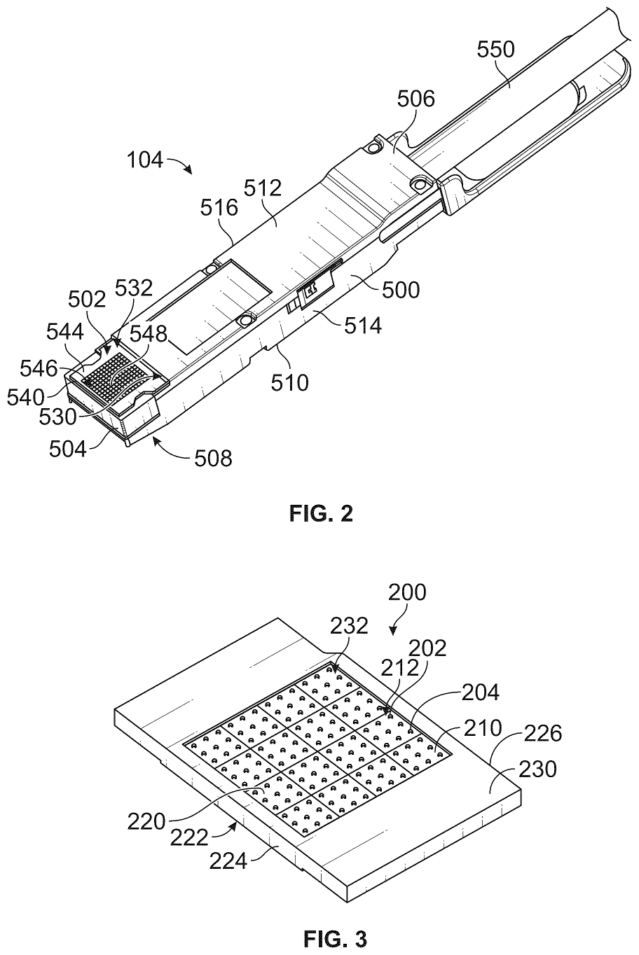

With additional reference to FIG. 2, which is a bottom perspective view of the pluggable module 104, the pluggable module 104 is a cable connector. For example, the pluggable module 104 may be an input/output (I/O) connector, such as a transceiver module. In various embodiments, the pluggable module 104 may be similar to a SFP, QSFP, OSFP or other I/O form factor.

The pluggable module 104 includes a module body 500 holding a module circuit board 502 (FIG. 2). The module body 500 extends between a front 504 and a rear 506. In an exemplary embodiment, the pluggable module 104 includes an actuation feature 508 at or near the front 504. The front 504 of the pluggable module 104 is configured to be loaded into the cage 120 for mating with the circuit card assembly 102. The actuation feature 508 is used to position the pluggable module 104 for mating with the socket connector 200. The module body 500 includes a top 510 and a bottom 512. The module body 500 includes a first side 514 and a second side 516. In the illustrated embodiment, the actuation feature 508 is a ramp at the top 510. The actuation feature 508 may be a cam surface. Other types of actuation features 508 may be used in alternative embodiments, such as a biasing element. The actuation features 508 may be located at other locations in alternative embodiments.

In an exemplary embodiment, the module body 500 includes guide features 520 configured to guide mating of the module body 500 with the circuit card assembly 102. Optionally, the guide features 520 extend longitudinally along the sides 514, 516 between the front 504 and the rear 506. The guide features 520 may be rails or ribs at the top 510. Other types of guide features may be provided in alternative embodiments, such as pins, shoulders, grooves, channels, and the like.

In an exemplary embodiment, the module body 500 includes a cavity 530 that receives the module circuit board 502. The module body 500 includes a window 532 open at the bottom 512 to expose the module circuit board 502 in the cavity 530. Optionally, the window 532 may be located proximate to the rear 506.

The module circuit board 502 includes a mating edge 540 (FIG. 2) extending between an upper surface (not shown) and a lower surface 544. The lower surface 544 is exposed in the window 532 at the bottom 512 of the module body 500. The module circuit board 502 includes a module contact array 546 of module contacts 548 at the lower surface 544 proximate to the mating edge 540. In an exemplary embodiment, the module contacts 548 are defined by circuits of the module circuit board 502, such as pads, traces, vias, and the like. In alternative embodiments, the module contacts 548 may be spring beam contacts having deflectable spring beams defining a compressible mating interface. The module contacts 548 are arranged in a plurality of rows and a plurality of columns. In an exemplary embodiment, the module contacts 548 are arranged in greater than three rows and arranged in greater than three columns. In the illustrated embodiment, the module contacts 548 are arranged in a 12×12 array; however, the module contacts 548 may be arranged in greater or fewer rows and in greater or fewer columns. Having a large number of rows and/or columns provides a dense mating interface for the pluggable module 104 having many high-speed signal lines through the pluggable module 104.

In an exemplary embodiment, the pluggable module 104 includes one or more cables 550. The cable 550 may be a fiber optic cable optically connected to the module circuit board 502. In alternative embodiments, the cables 550 may be copper cables having electrical conductors configured to be directly terminated to the module circuit board 502. For example, the cables 550 may be high speed differential pair cables.

In an exemplary embodiment, the pluggable module 104 includes a heat sink 552 at the top 510. The heat sink 552 includes a plurality of heat dissipating fins extending along the top 510. The heat dissipating fins may extend longitudinally between the front 504 and the rear 506. The heat dissipating fins allow airflow therethrough for cooling the heat dissipating fins.

FIG. 3 is a perspective view of the socket connector 200 in accordance with an exemplary embodiment. The socket connector 200 includes socket contacts 202 arranged in an array. The socket connector 200 includes a socket substrate 210 holding the socket contacts 202. In an exemplary embodiment, the socket contacts 202 are arranged in an upper contact array at an upper surface 220 of the socket substrate 210 and a lower contact array at a lower surface 222 of the socket substrate 210. The socket contacts 202 include mating ends 204 at the upper surface 220 and the lower surface 222. The socket contacts 202 extend between the first or upper mating ends and the second or lower mating ends.

The socket substrate 210 extends between a front 224 of the socket connector 200 and a rear 226 of the socket connector 200. In an exemplary embodiment, the socket substrate 210 is a molded part. The socket substrate 210 may be planar, such as being a plate. In an exemplary embodiment, the socket substrate 210 includes contact channels 212 that hold the socket contacts 202. In other various embodiments, the socket substrate 210 is a circuit board having circuits, such as pads, traces, vias and the like, forming the socket contacts 202. For example, the socket substrate 210 may include plated vias extending between contact pads on the upper surface 220 and the lower surface 222.

In an exemplary embodiment, the socket contacts 202 are stamped and formed contacts having spring beams forming upper contacts at the top of the socket connector 200 and spring beams forming lower contacts at the bottom of the socket connector 200. The socket contacts 202 are compressible, such as at the upper contacts and/or the lower contacts. In an exemplary embodiment, the socket contacts 202 include separable mating interfaces at the upper mating ends and/or the lower mating ends. In an exemplary embodiment, the socket contacts 202 are configured to mate with the pluggable module 104 at the upper mating ends and are configured to mate with the interposer 300 at the lower mating ends. The spring contacts are deflectable when mated with the pluggable module 104 or the interposer 300. For example, the pluggable module 104 may be coupled to the socket connector 200 from above to compress the spring contacts causing the mating interfaces to be spring biased against the pluggable module 104 or the interposer 300. In an exemplary embodiment, the upper mating interfaces are co-planer for mating with the pluggable module 104 from above and the lower mating interfaces are co-planar for mating with the interposer 300. The socket contacts 202 form a land grid array at the upper surface 220 and a land grid array at the lower surface 222. In other various embodiments, the socket contacts 202 may include solder balls forming a ball grid array at the upper surface 220 and/or the lower surface 222. In other various embodiments, the socket contacts 202 may be conductive polymer columns.

In an exemplary embodiment, the socket connector 200 includes a socket frame 230 holding the socket substrate 210. In the illustrated embodiment, the socket frame 230 is coupled to edges of the socket substrate 210. In other various embodiments, the socket frame 230 may enclosed the socket substrate 210, such as along the sides and/or the ends of the socket substrate 210. The socket frame 230 may be coupled to another component, such as the host circuit board 110 or the cage 120 to position the socket substrate 210 from mating with the pluggable module 104 and the interposer 300. The socket frame 230 may limit compression of the upper contacts and/or the lower contacts. In an exemplary embodiment, the socket frame 230 is a plastic frame extending along both sides and both ends of the socket substrate 210 to form a rectangular socket cavity 232. The socket cavity 232 may have other shapes in alternative embodiments.

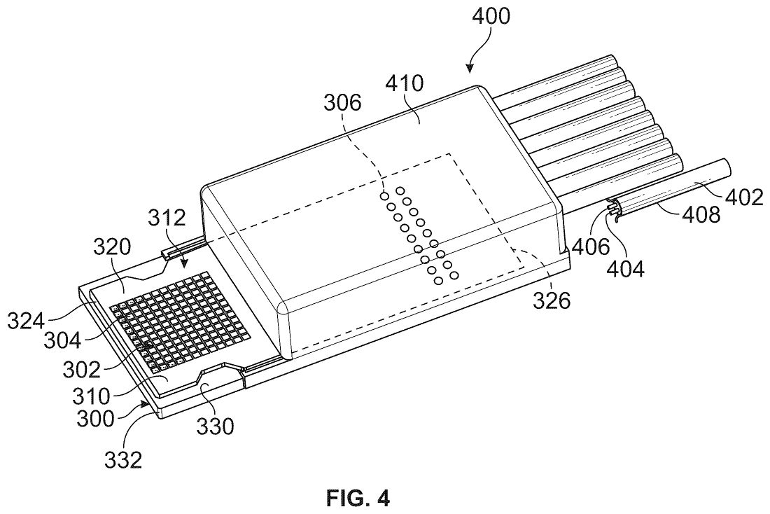

FIG. 4 is a perspective view of the interposer 300 in accordance with an exemplary embodiment. The interposer 300 includes interposer contacts 302 arranged in an array. The interposer 300 includes an interposer substrate 310 holding the interposer contacts 302. In an exemplary embodiment, the interposer contacts 302 are arranged in a contact array along a surface 320 of the interposer substrate 310, such as along an upper surface of the interposer substrate 310.

The interposer substrate 310 extends between a front 324 of the interposer 300 and a rear 326 (shown in phantom) of the interposer 300. In an exemplary embodiment, the interposer substrate 310 includes an interposer circuit board 312. The interposer contacts 302 are circuits of the interposer circuit board 312. For example, the interposer contacts 302 are contact pads at the mating end of the interposer circuit board 312. The interposer contacts 302 have mating ends 304 at the front 324 of the interposer circuit board 312. The mating end 304 are configured to be mated with the corresponding socket contacts 202 of the socket connector 200 (FIG. 3). The interposer contacts 302 have terminating ends 306 at the rear 326 of the interposer circuit board 312. The terminating ends 306 are configured to be terminated to the cable assembly 400. For example, conductors of the individual cables of the cable assembly 400 may be terminated directly to the terminating ends 306. In other various embodiments, contacts may be provided between the conductors of the individual cables and the terminating ends 306 of the interposer contacts 302. In other various embodiments, the interposer substrate 310 is a molded part, such as a plate, holding an individual interposer contacts, such as stamped and formed contacts.

In an exemplary embodiment, the interposer 300 includes an interposer frame 330 holding the interposer substrate 310. The interposer frame 330 may support the cable assembly 400. For example, the cable assembly 400 may be coupled to the interposer frame 330. The interposer frame 330 includes a tray or tongue 332 at the front that supports the mating end of the interposer circuit board 312. The tongue 332 extends forward of the cable assembly 400. The interposer circuit board 312 is exposed along the top of the tongue 332 to interface with the socket connector 200. Other arrangements or orientations are possible in alternative embodiments. The interposer 300 may have other shapes in alternative embodiments.

In an exemplary embodiment, the cable assembly 400 includes a plurality of cables 402 that extend into a cable housing 410. The cable housing 410 is coupled to the interposer 300, such as to the interposer frame 330. In various embodiments, the cable housing 410 may provide shielding for the cables 402. In an exemplary embodiment, the cables 402 are high speed electrical cables. In various embodiments, the cables 402 are twinaxial cables having a pair of conductors 404 surrounded by an insulator 406 and a cable shield 408. The cable shield 408 provides electrical shielding for the conductors 404. The conductors 404 may be configured to transmit differential signals. Other types of cables may be used in alternative embodiments, such as coaxial cables, twisted-pair cables, or other types of cables. In other various embodiments, the cables 402 may be flexible circuits. In an exemplary embodiment, the cable assembly 400 includes a shielding structure at the interface between the ends of the cables 402 and the interposer 300. For example, the conductors 404 may be terminated to the terminating ends 306 in shielded pockets. For example, each of the cables 402 may be shielded from adjacent cables by the shielding structure.

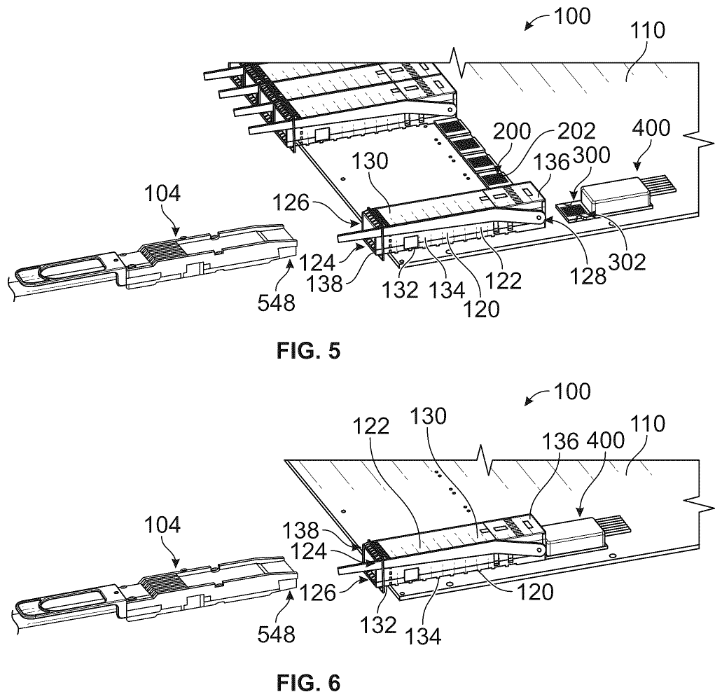

FIG. 5 is a front perspective view of the electrical connector system 100 in accordance with an exemplary embodiment with various components removed to illustrate other components of the electrical connector system 100. FIG. 6 is another front perspective view of the electrical connector system 100 in accordance with an exemplary embodiment. FIGS. 5 and 6 show the pluggable module 104 poised for loading into the cage 120. FIGS. 5 and 6 show the cable assembly 400 coupled to the interposer 300. FIG. 5 illustrates the interposer 300 poised for loading into the cage 120 while FIG. 6 illustrates the interposer 300 plugged into the cage 120.

In an exemplary embodiment, the cage 120 is enclosed and provides electrical shielding for the components. The cage 120 includes a plurality of walls 122 that define one or more module channels 124 for receipt of corresponding pluggable module(s) 104. The walls 122 may be walls defined by solid sheets, perforated walls to allow airflow therethrough, walls with cutouts, such as for a heatsink or heat spreader to pass therethrough, or walls defined by rails or beams with relatively large openings. In an exemplary embodiment, the cage 120 is a shielding, stamped and formed metallic cage member. In other embodiments, the cage 120 may be open between frame members, such as rails or beams, to guide mating of the pluggable module 104 with the socket connector 200.

In the illustrated embodiment, the cage 120 is a single port cage configured to receive a single pluggable module 104 in a single module channel 124. However, in alternative embodiments, the cage 120 may include multiple ports to receive multiple pluggable modules, such as being a stacked cage member having upper and lower module channels or having side-by-side module channels 124. The module channels may be arranged in a single column, however, the cage 120 may include multiple columns of ganged module channels in alternative embodiments (for example, 2×2, 3×2, 4×2, 4×3, etc.). The cage 120 includes a front port 126 providing access to the module channel 124. The pluggable module 104 is plugged into the module channel 124 through the port 126. The cage 120 may include a rear port 128 providing access to the module channel 124. The interposer 300 is plugged into the module channel 124 through the rear port 128.

In an exemplary embodiment, the walls 122 of the cage 120 include a top wall 130, a bottom wall 132, and side walls 134 extending between the top wall 130 and the bottom wall 132. The bottom wall 132 may rest on the host circuit board 110. However, in alternative embodiments, the cage 120 may be provided without the bottom wall 132. Optionally, the walls 122 of the cage 120 may include a rear wall 136 at the rear of the cage 120 and a front wall 138 at the front of the cage 120. The port 126 is provided in the front wall 138. The rear port 128 is provided in the rear wall 136. The walls 122 define a cavity, which forms the module channel(s) 124. The cavity is defined by the top wall 130, the bottom wall 132, the side walls 134, the rear wall 136 and the front wall 138. Other walls 122 may separate or divide the cavity into various module channels 124. For example, the walls 122 may include a channel separator between upper and lower module channels 124. The walls 122 may include divider walls, parallel to the side walls 134, extending between the top wall 130 and the bottom wall 132 to separate adjacent module channels 124 from each other.

In an exemplary embodiment, the cage 120 may include one or more gaskets at the front wall 138 for providing electrical shielding for the module channel 124. For example, the gaskets may be configured to electrically connect with the pluggable module 104 received in the module channel 124. The gaskets may be configured to electrically connect to a panel or bezel. In an exemplary embodiment, the cage 120 may include one or more gaskets at the rear wall 136 for providing electrical shielding for the module channel 124. For example, the gaskets may be configured to electrically connect with the interposer 300 received in the module channel 124.

In an exemplary embodiment, the cage 120 may include one or more heat sinks (not shown) for dissipating heat from the pluggable module 104. For example, the heat sink may be coupled to the top wall 130 and extend through an opening in the top wall 130 to engage the pluggable module 104 and dissipate heat from the pluggable module 104.

In an exemplary embodiment, the socket connector 200 is received in the cage 120, such as proximate to the rear wall 136. The socket connector 200 may be coupled to the side walls 134 to suspend the socket connector 200 in the cavity. For example, the pluggable module 104 may be received between the socket connector 200 and the top wall 130 and the interposer 300 may be received between the socket connector 200 and the bottom wall 132 or the host circuit board 110. In alternative embodiments, the pluggable module 104 may be received below the socket connector 200 between the socket connector 200 and the bottom wall 132 and the interposer 300 may be received above the socket connector 200 between the socket connector 200 and the top wall 130. In other alternative embodiments, the socket connector 200 may be located behind the rear wall 136 exterior of the cage 120 and extend into the cavity to interface with the pluggable module(s) 104. In an exemplary embodiment, the cage 120 receives a single socket connector 200. However, multiple socket connectors 200 may be received in the cage 120 in other embodiments.

In an exemplary embodiment, the pluggable module 104 is loaded through the front wall 138 in a module loading direction (for example, horizontally) to mate with the socket connector 200 and the interposer 300 is loaded through the rear wall 136 to mate with the socket connector 200. For example, the socket connector 200 is located at or near the rear wall 136. The pluggable module 104 is plugged into the cavity through the front port 126 at the front wall 138 and the interposer 300 is plugged into the cavity through the rear port 128 to interface with the socket connector 200. The contacts of the components may form a contact stack. For example, the module contacts 548 of the pluggable module 104, the socket contacts 202 of the socket connector 200 and the interposer contacts 302 of the interposer 300 may be arranged in a stacked configuration. The shielding walls 122 of the cage 120 provide electrical shielding around the pluggable module 104, the socket connector 200 and the interposer 300, such as around the mating interfaces.

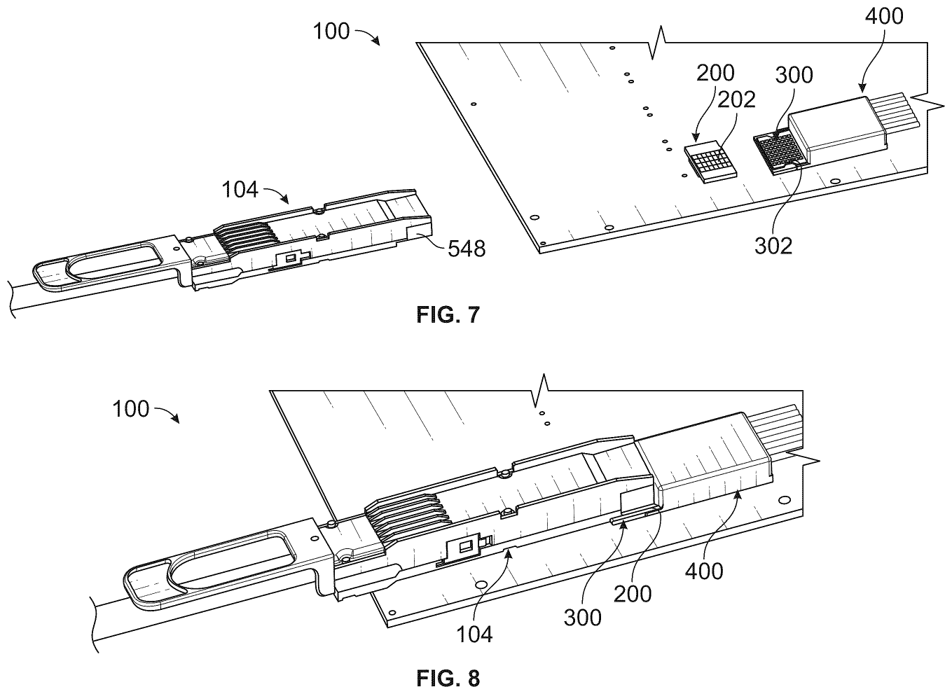

With additional reference to FIGS. 7 and 8, FIG. 7 is a perspective view of a portion of the electrical connector system 100 showing the pluggable module 104 and the interposer 300 poised for coupling with the socket connector 200 and FIG. 8 is a perspective view of a portion of the electrical connector system 100 showing the pluggable module 104 and the interposer 300 coupled to the socket connector 200. The cage 120 is removed in FIGS. 7 and 8 to illustrate the components of the electrical connector system 100. The socket connector 200 and the interposer 300 form a very short electrical path between the pluggable module 104 and the cable assembly 400 to form a reliable over the board connector system to allow high-speed data communication between the pluggable module 104 and the electrical device 106. FIG. 8 shows the components forming the stack. The module contacts 548 of the pluggable module 104, the socket contacts 202 of the socket connector 200 and the interposer contacts 302 of the interposer 300 are aligned/stacked. For example, the interposer 300 is located below the socket connector 200 and the pluggable module 104 is located above the socket connector 200. When mated, the socket contacts 202 form signal paths between the module contacts 548 and the interposer contacts 302. In an exemplary embodiment, the socket contacts 202 are compressible. For example, the socket contacts 202 may be compressed vertically between the pluggable module 104 and the interposer 300. In an exemplary embodiment, the loading mechanism 150 is used to load the contacts during mating. For example, the loading mechanism 150 may compress the socket contacts 202 in a contact mating direction (for example, vertically) to create reliable electrical paths through the socket connector 200.

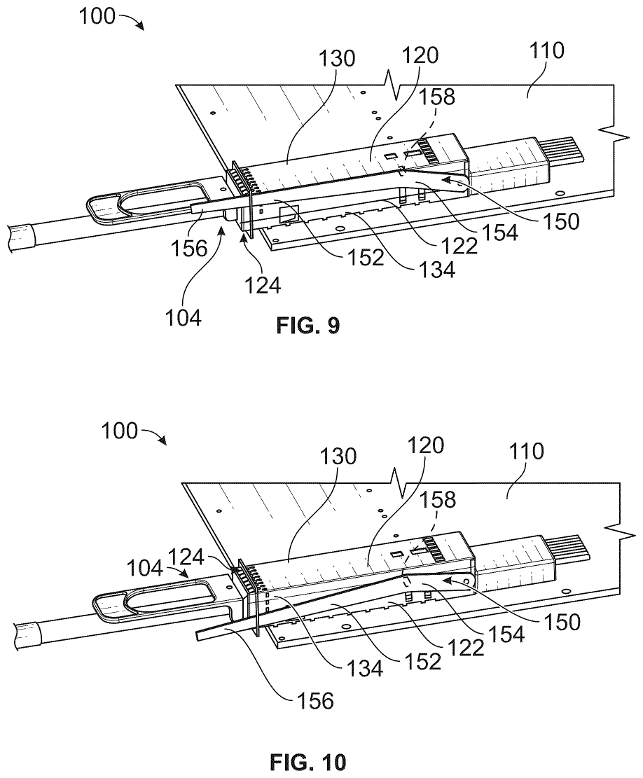

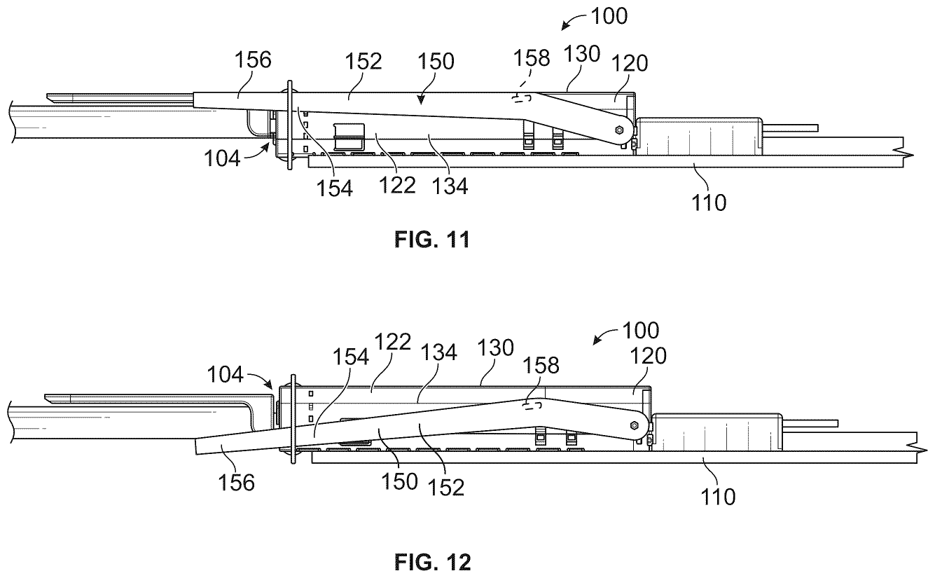

FIG. 9 is a perspective view of the electrical connector system 100 showing the pluggable module 104 and the interposer 300 plugged into the cage 120 and showing the loading mechanism 150 in an un-actuated position. FIG. 10 is a perspective view of the electrical connector system 100 showing the pluggable module 104 and the interposer 300 plugged into the cage 120 and showing the loading mechanism 150 in an actuated position. FIG. 11 is a side view of the electrical connector system 100 showing the pluggable module 104 and the interposer 300 plugged into the cage 120 and showing the loading mechanism 150 in an un-actuated position. FIG. 12 is a side view of the electrical connector system 100 showing the pluggable module 104 and the interposer 300 plugged into the cage 120 and showing the loading mechanism 150 in an actuated position.

In an exemplary embodiment, the loading mechanism 150 moves one or more of the components relative to each other to compress the socket contacts 202, such as in the contact mating direction. For example, the loading mechanism 150 may move the pluggable module 104 in a downward direction to compress the socket contacts 202 between the pluggable module 104 and the interposer 300. In various embodiments, a lifter spring may be positioned forward of the socket connector 200, such as along the host circuit board 110 in the module channel 124. The lifter spring is used to lift the pluggable module 104 in an upward direction towards the top wall 130 of the cage 120. The lifter spring elevates the pluggable module 104 to avoid interference or wiping of the contacts as the mating end of the pluggable module 104 is moved in the loading direction to a position above the socket connector 200. The spring force of the lifter spring may be overcome by the downward loading force of the loading mechanism 150 to move the pluggable module 104 and the contact mating direction.

In the illustrated embodiment, the loading mechanism 150 includes a latch 152 coupled to the cage 120; however, other types of loading mechanisms may be used in alternative embodiments, such as a biasing member, a spring arm, a rotating cam, a linear actuator, a roller bearing, a lever, and electronic actuator, or another type of actuator. The latch 152 may be pivotably coupled to one of the walls 122, such as the side wall 134. The latch 152 includes a latch arm 154 extending between a handle 156 and an actuator 158. In the illustrated embodiment, the latch arm 154 extends along the exterior of the cage 120, such as along the side wall 134. The latch 152 extends to the front of the cage 120. For example, the handle 156 is accessible forward of the cage 120. The actuator 158 extends through the side wall 134 into the interior of the module channel 124 to interface with the components, such as the pluggable module 104. The latch 152 may be actuated by moving between a resting or released position and an actuated position. For example, the latch 152 may be moved in a downward actuation direction to the actuated position. The downward movement is transferred to the pluggable module 104 to press the pluggable module 104 downward toward the socket connector 200 to compress the socket contacts 202.

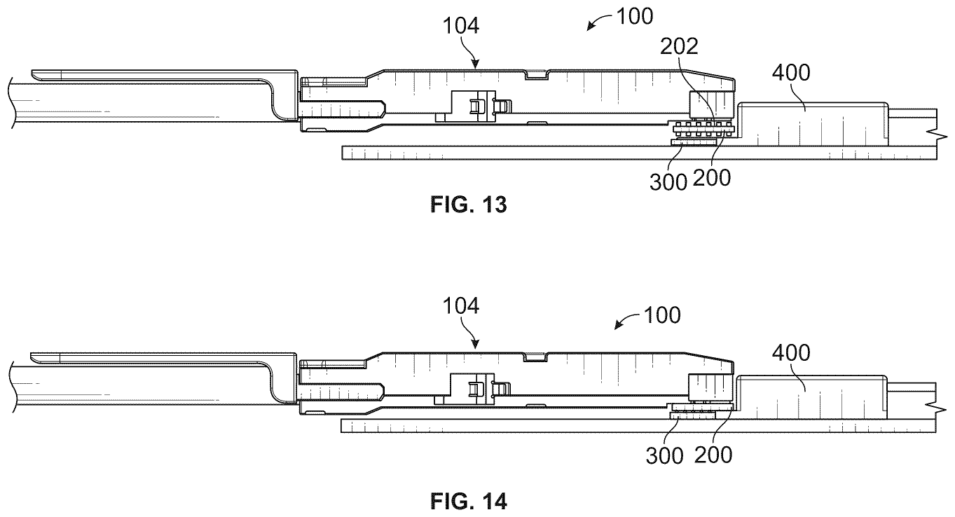

FIG. 13 is a side view of the electrical connector system 100 showing the pluggable module 104, the socket connector 200, and the interposer 300 in an unmated state. FIG. 14 is a side view of the electrical connector system 100 showing the pluggable module 104, the socket connector 200, and the interposer 300 in a mated state. In an exemplary embodiment, the pluggable module 104 is moved downward in a contact mating direction by the loading mechanism 150 to mate the pluggable module 104 with the socket connector 200. In an exemplary embodiment, the socket connector 200 may be pressed downward and mated with the interposer 300 by the loading mechanism 150. For example, as the pluggable module 104 moves downward, the pluggable module 104 moves the socket connector 200 downward to mate with the interposer 300. The socket contacts 202 are compressed between the pluggable module 104 and the interposer 300. When mated, the socket contacts 202 form signal paths between the pluggable module 104 and the interposer 300. The socket connector 200 and the interposer 300 form a very short electrical path between the pluggable module 104 and the cable assembly 400 to form a reliable over the board connector system to allow high-speed data communication between the pluggable module 104 and the electrical device 106.

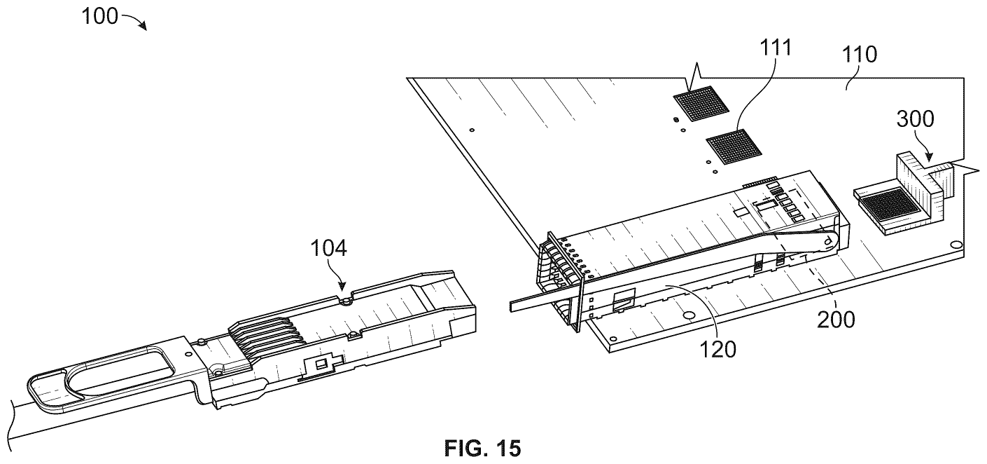

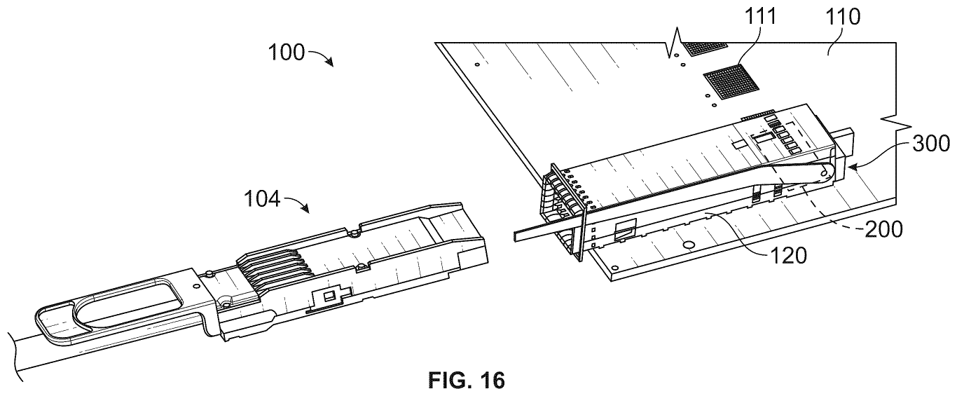

FIG. 15 is a front perspective view of the electrical connector system 100 showing the interposer 300 in accordance with an exemplary embodiment poised for loading into the cage 120. FIG. 16 is a front perspective view of the electrical connector system 100 showing the interposer 300 loaded into the cage 120. FIGS. 15 and 16 show the interposer 300 as a board terminated interposer rather than the cable terminated interposer of FIG. 1. In an exemplary embodiment, the interposer 300 is configured to be electrically connected to the host circuit board 110 rather than being terminated to the cables 402 of the cable assembly 400 (shown in FIG. 4). The board terminated interposer and the cable terminated interposer may be direct replacements for each other. For example, the electrical connector system 100 may be used interchangeably with the board terminated interposer or the cable terminated interposer. For example, the board terminated interposer and the cable terminated interposer may have similar sizes, shapes, and contact arrangements such that either of the interposer's may be plugged into the cage 120 to mate with the socket connector 200.

In an exemplary embodiment, the host circuit board 110 includes board contacts 111 at the mounting area. The board contacts 111 may be formed by circuits of the host circuit board 110. For example, the board contacts 111 may be contact pads, traces, vias, and the like of the host circuit board 110. The board contacts 111 are arranged in an array similar to the array of the interposer contacts and the socket contacts. The interposer 300 is electrically connected to the host circuit board 110 at the board contacts 111. Power and/or signals may be transmitted between the host circuit board 110 and the interposer 300 the electrical device 106 is electrically connected to the pluggable module 104 through the circuits of the host circuit board 110, through the interposer 300 and through the socket connector 200.

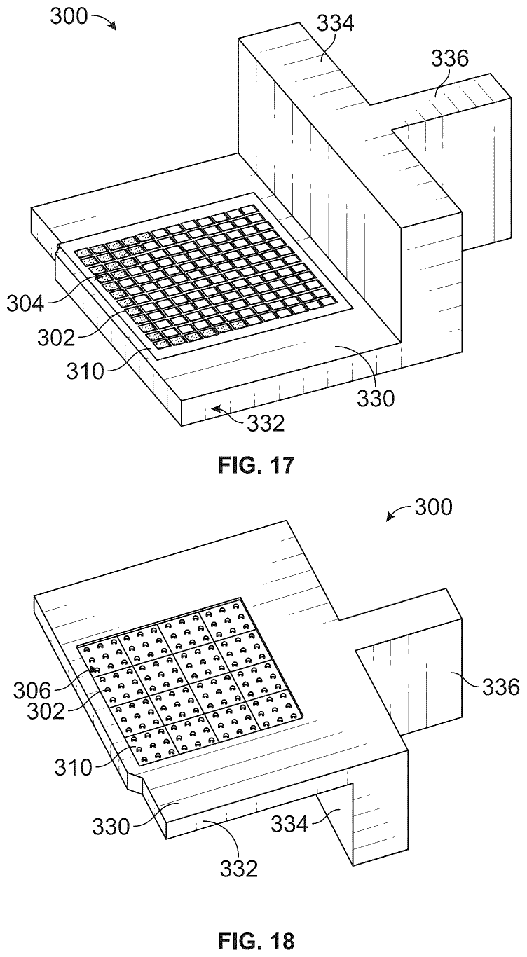

FIG. 17 is a top perspective view of the interposer 300 in accordance with an exemplary embodiment. FIG. 18 is a bottom perspective view of the interposer 300 in accordance with an exemplary embodiment. The interposer 300 includes the interposer substrate 310 and the interposer contacts 302 held by the interposer substrate 310 in an array. The interposer substrate 310 is arranged in the interposer frame 330, such as along the tongue 332. In an exemplary embodiment, the interposer frame 330 includes a support wall 334 rearward of the tongue 332 and a handle 336 extending from the support wall 334. The handle 336 provides a gripping surface for manipulating the interposer 300, such as for loading the interposer 300 into the cage 120 or removing the interposer 300 from the cage 120. The interposer frame 330 may have other shapes or include other elements in alternative embodiments.

In an exemplary embodiment, the interposer contacts 302 extend between mating ends 304 and terminating ends 306. In an exemplary embodiment, the mating ends 304 are provided at a top surface of the interposer substrate 310 and the terminating ends 306 are provided at a bottom surface of the interposer substrate 310. Optionally, the interposer contacts 302 may pass straight through the interposer substrate 310 such that the interposer contacts 302 have short electrical length. In the illustrated embodiment, the mating ends 304 include contact pads defining separable mating interfaces for mating with the socket contacts 202 of the socket connector 200. Other types of mating interfaces may be provided in alternative embodiments, such as spring contacts, solder balls, or other types of mating interfaces. In the illustrated embodiment, the terminating ends 306 include spring contacts defining separable mating interfaces for mating with the board contacts 111 of the host circuit board 110 (FIG. 15). Other types of mating interfaces may be provided in alternative embodiments, such as contact pads, solder balls, or other types of mating interfaces. The interposer 300 may provide electrical shielding between various interposer contacts 302, such as between individual interposer contacts 302 or between pairs of the interposer contacts 302.

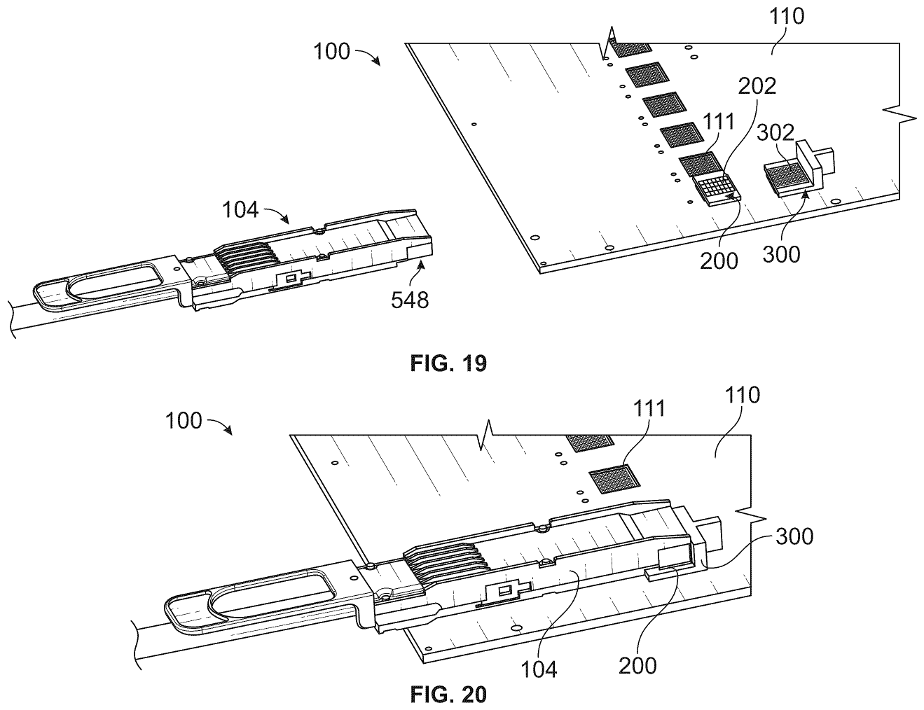

FIG. 19 is a perspective view of a portion of the electrical connector system 100 showing the pluggable module 104 and the interposer 300 poised for coupling with the socket connector 200. FIG. 20 is a perspective view of a portion of the electrical connector system 100 showing the pluggable module 104 and the interposer 300 coupled to the socket connector 200. The cage 120 is removed in FIGS. 19 and 20 to illustrate the components of the electrical connector system 100. The socket connector 200 and the interposer 300 form a very short electrical path between the pluggable module 104 and the host circuit board 110. FIG. 20 shows the components forming the stack. The module contacts 548 of the pluggable module 104, the socket contacts 202 of the socket connector 200, the interposer contacts 302 of the interposer 300, and the board contacts 111 of the host circuit board 110 are aligned/stacked. For example, the interposer 300 is located between the socket connector 200 and the host circuit board 110 and the socket connector 200 is located between the interposer 300 and the pluggable module 104.

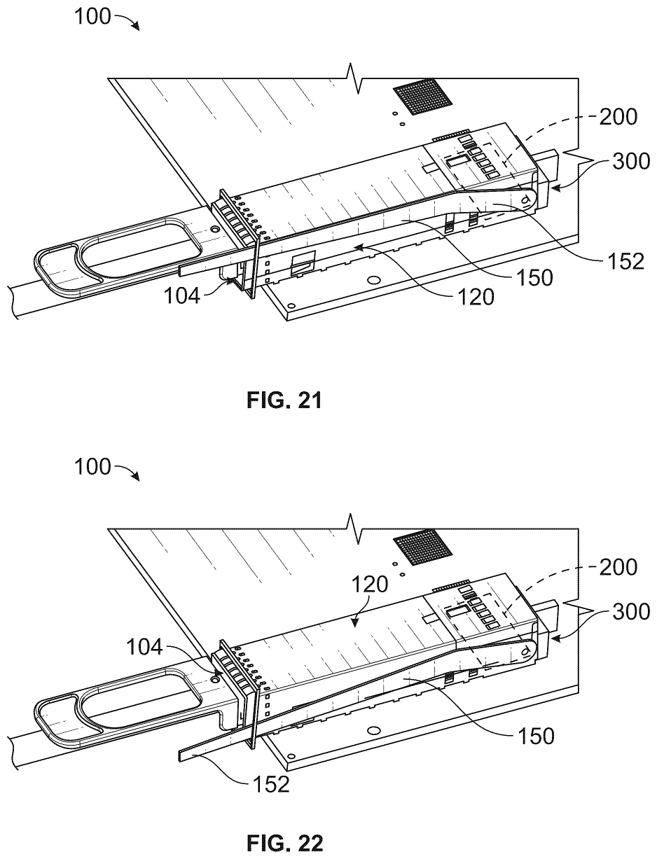

When mated, the socket contacts 202 and the interposer contacts 302 form signal paths between the module contacts 548 and the board contacts 111. In an exemplary embodiment, the socket contacts 202 are compressible. For example, the socket contacts 202 may be compressed vertically between the pluggable module 104 and the interposer 300. Optionally, the interposer contacts 302 may be compressible, such as at the interface with the socket connector 200 and/or the interface with the host circuit board 110. For example, the terminating ends of the interposer contacts 302 may be compressible. In an exemplary embodiment, the loading mechanism 150 (shown in FIG. 21) is used to load the contacts during mating. For example, the loading mechanism 150 may compress the socket contacts 202 and/or the interposer contacts 302 in a contact mating direction (for example, vertically) to create reliable electrical paths.

FIG. 21 is a perspective view of the electrical connector system 100 showing the pluggable module 104 and the interposer 300 plugged into the cage 120 and showing the loading mechanism 150 in an un-actuated position. FIG. 22 is a perspective view of the electrical connector system 100 showing the pluggable module 104 and the interposer 300 plugged into the cage 120 and showing the loading mechanism 150 in an actuated position.

In an exemplary embodiment, the loading mechanism 150 moves one or more of the components relative to each other to compress the socket contacts 202, such as in the contact mating direction. For example, the loading mechanism 150 may move the pluggable module 104 in a downward direction to compress the socket contacts 202 between the pluggable module 104 and the interposer 300. For example, the latch 152 may be moved in a downward actuation direction to the actuated position. The downward movement is transferred to the pluggable module 104 to press the pluggable module 104 downward toward the socket connector 200 to compress the socket contacts 202.

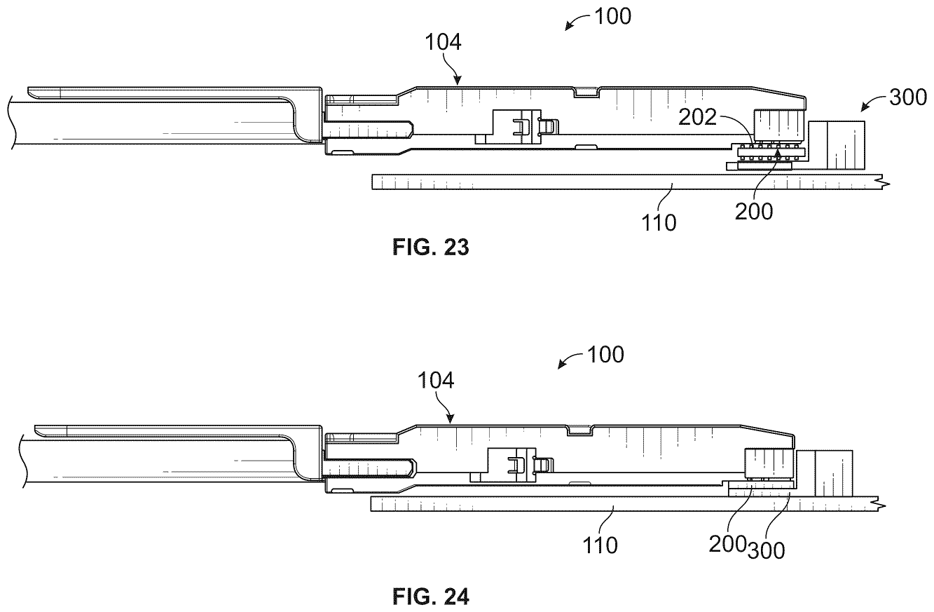

FIG. 23 is a side view of the electrical connector system 100 showing the pluggable module 104, the socket connector 200, and the interposer 300 in an unmated state. FIG. 24 is a side view of the electrical connector system 100 showing the pluggable module 104, the socket connector 200, and the interposer 300 in a mated state. FIGS. 23 and 24 show the electrical connector system 100 without the cage 120 to illustrate the components of the electrical connector system 100.

In an exemplary embodiment, the pluggable module 104 is moved downward in a contact mating direction by the loading mechanism 150 to mate the pluggable module 104 with the socket connector 200. In an exemplary embodiment, the socket connector 200 may be pressed downward and mated with the interposer 300 by the loading mechanism 150. For example, as the pluggable module 104 moves downward, the pluggable module 104 moves the socket connector 200 downward to mate with the interposer 300. The socket contacts 202 are compressed between the pluggable module 104 and the interposer 300. When mated, the socket contacts 202 form signal paths between the pluggable module 104 and the interposer 300. The socket connector 200 and the interposer 300 form a very short electrical path between the pluggable module 104 and the host circuit board 110 to form a reliable, high-speed data communication between the pluggable module 104 and the electrical device 106.

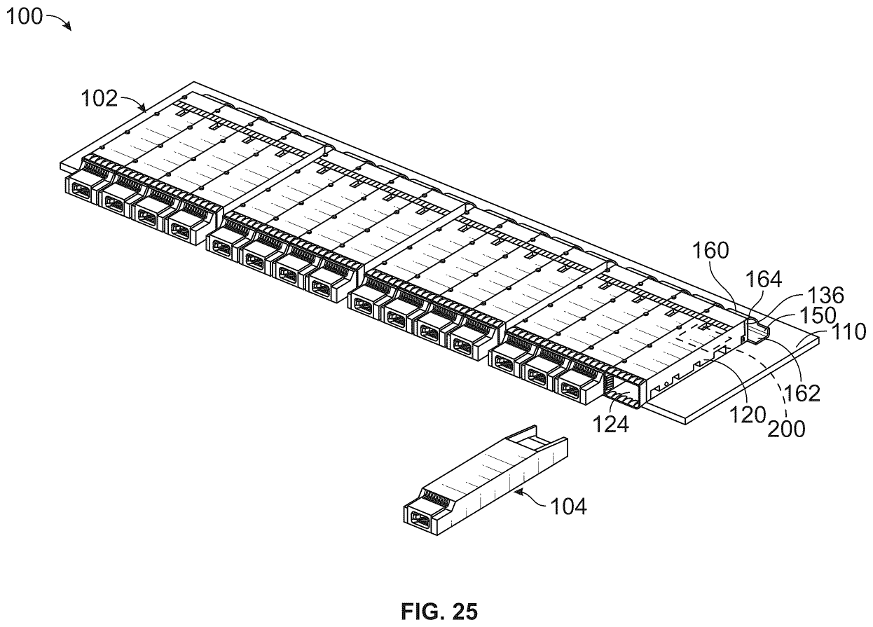

FIG. 25 is a front perspective view of the electrical connector system 100 formed in accordance with an exemplary embodiment. FIG. 25 illustrates the circuit card assembly 102 using a different type of loading mechanism 150. The loading mechanism 150 includes a spring latch 160 configured to interface with the pluggable module 104. In the illustrated embodiment, the loading mechanism 150 is mounted to the host circuit board 110 rearward of the cage 120. The spring latch 160 includes a base 162 mounted to the host circuit board 110 and a spring arm 164 extending from the base 162. The spring arm 164 extends through the rear wall 136 into the module channel 124 to interface with the pluggable module 104 when the pluggable module 104 is plugged into the module channel 124. The spring arm 164 is configured to press the pluggable module 104 downward in a mating direction to mate the pluggable module 104 with the socket connector 200.

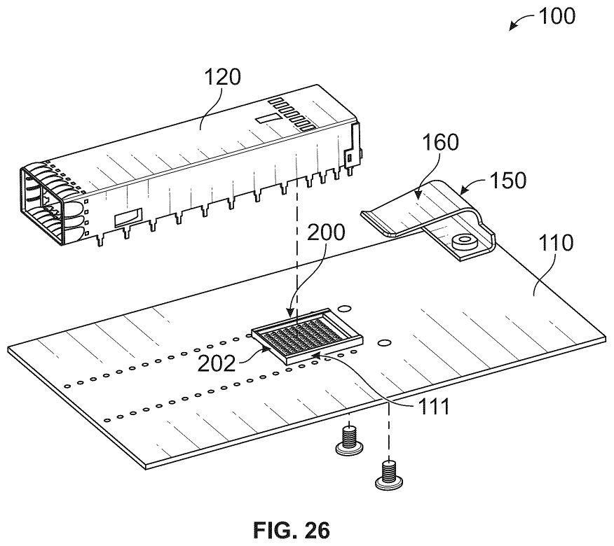

FIG. 26 is an exploded view of a portion of the electrical connector system 100 in accordance with an exemplary embodiment. FIG. 26 shows the host circuit board 110, the cage 120, the loading mechanism 150, and the socket connector 200 in accordance with an exemplary embodiment. In the illustrated embodiment, the electrical connector system 100 is provided without the interposer 300 (Shown in FIG. 1). In contrast, the socket connector 200 is configured to be directly connected to the host circuit board 110. For example, the socket contacts 202 may be terminated directly to the board contacts 111 of the host circuit board 110. However, in alternative embodiments, the interposer 300 may be utilized between the socket connector 200 and the host circuit board 110. FIG. 26 shows the loading mechanism 150 including the spring latch 160 configured to be mounted to the host circuit board 110. Other types of loading mechanisms may be used in alternative embodiments. For example, when the interposer 300 is utilized, the spring latch 160 may be mounted to the interposer 300 rather than being mounted to the host circuit board 110.

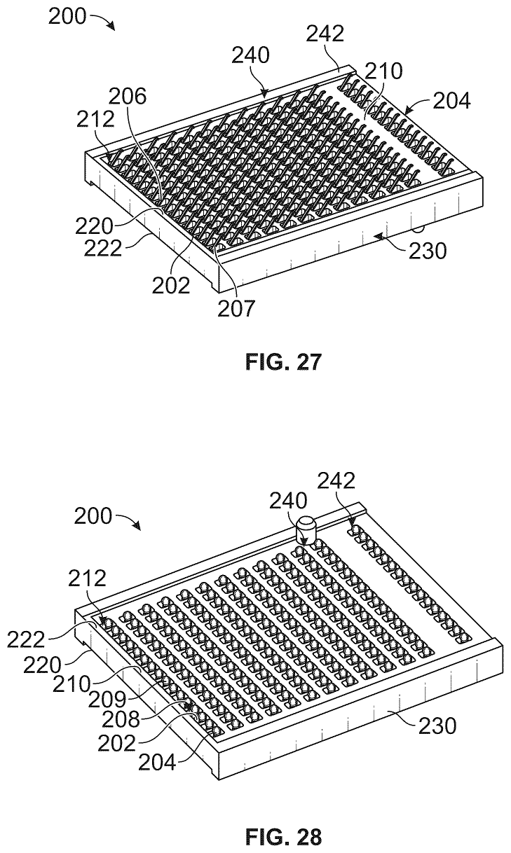

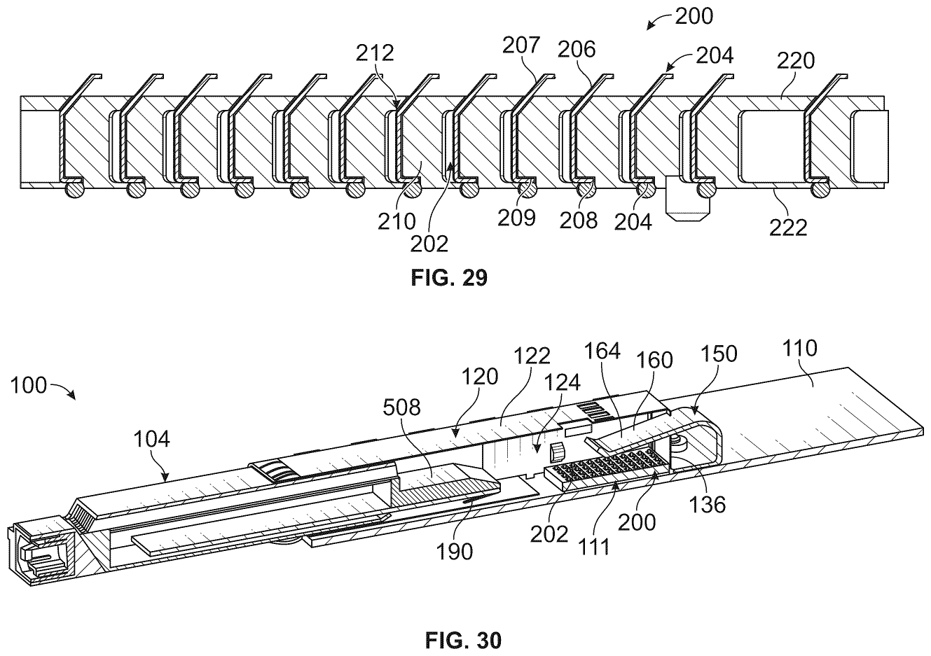

FIG. 27 is a top perspective view of the socket connector 200 in accordance with an exemplary embodiment. FIG. 28 is a bottom perspective view of the socket connector 200 in accordance with an exemplary embodiment. FIG. 29 is a cross-sectional view of the socket connector 200 in accordance with an exemplary embodiment. In the illustrated embodiment, the socket contacts 202 include an upper contact array of upper contacts 206 and a lower contact array of lower contacts 208. In the illustrated embodiment, the upper contact array is a land grid array and the lower contact array is a ball grid array. For example, the mating ends 204 of the upper contacts 206 includes spring beams 207 and the mating ends 204 of the lower contacts 208 include solder pads 209 having solder balls applied to the solder pads 209. The solder balls are configured to be soldered to the board contacts 111 of the host circuit board 110. The spring beams 206 are deflectable and are configured to be mated with the module contacts of the pluggable module 104.

In an exemplary embodiment, the socket contacts 202 are stamped and formed contacts. The socket contacts 202 are loaded into the contact channels 212 of the socket substrate 210. In an exemplary embodiment, the socket substrate 210 is a molded part, such as a plastic frame having the contact channels 212. The socket substrate 210 may be received in a separate socket frame. Alternatively, the socket frame 230 may be integral with the socket substrate 210, such as being co-molded with the socket substrate 210. The socket frame 230 may extend along the sides and/or the ends of the socket substrate 210. The upper contacts 206 are provided at the upper surface 220 of the socket substrate 210. The lower contacts 208 are provided at the lower surface 222 of the socket substrate 210. In an exemplary embodiment, the socket contacts 202 are arranged in a first array 240 defining a high speed signal array and a second array 242 defining a low speed signal and power array. The socket contacts 202 in the first array 240 include both signal contacts and ground contacts. Optionally, the signal contacts may be arranged in pairs with ground contacts interspersed between the pairs of the signal contacts. Other arrangements are possible in alternative embodiments.

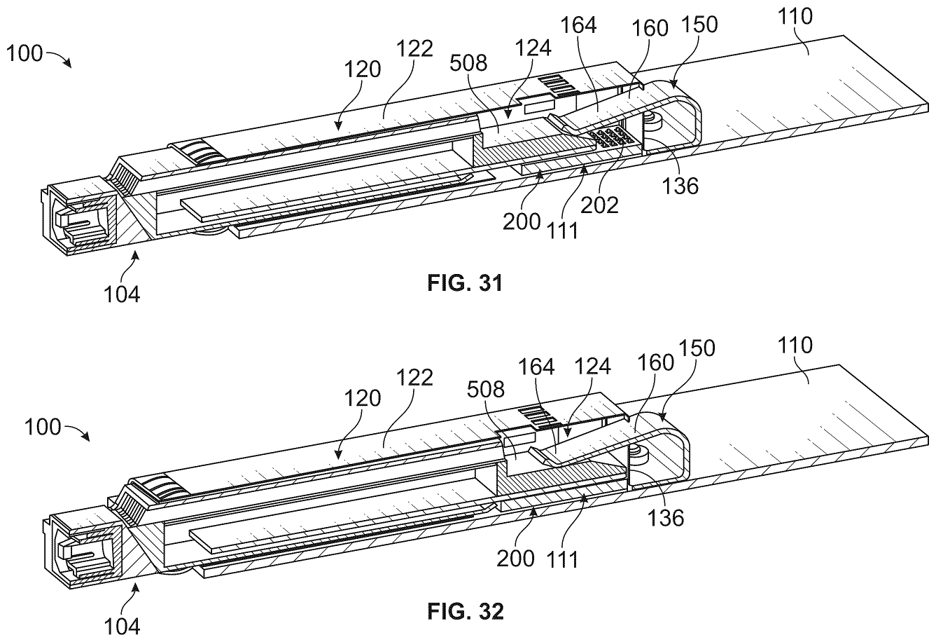

FIG. 30-32 illustrate a mating sequence of the electrical connector system 100 in accordance with an exemplary embodiment. FIG. 30 is a sectional view of the electrical connector system 100 showing the pluggable module 104 partially loaded into the cage 120. FIG. 31 is a sectional view of the electrical connector system 100 showing the pluggable module 104 partially loaded into the cage 120 and initially interfacing with the loading mechanism 150. FIG. 32 is a sectional view of the electrical connector system 100 showing the pluggable module 104 fully loaded into the cage 120 and mated with the socket connector 200. The pluggable module 104 is loaded into the cage 120 in a module loading direction (for example, horizontally). The loading mechanism 150 moves the pluggable module 104 in a contact mating direction (for example, vertically) that is transverse to the module loading direction. Optionally, the contact mating direction may be generally perpendicular to the module loading direction. The socket contacts 202 are compressed when the pluggable module 104 is moved in the contact mating direction to create a reliable electrical connection between the pluggable module 104 and the socket connector 200.

In an exemplary embodiment, the spring latch 160 is mounted to the host circuit board 110 rearward of the cage 120. The spring arm 164 extends through an opening in the rear wall 136 of the cage 120 into the module channel 124. The spring arm 164 is located above the socket connector 200. The spring arm 164 is configured to engage the pluggable module 104 to press the pluggable module 104 in a downward direction to mate the pluggable module 104 with the socket connector 200. The spring arm 164 presses the pluggable module 104 downward to compress the socket contacts 202. In an exemplary embodiment, the spring arm 164 engages the actuation feature 508 at the top of the pluggable module 104 to press the pluggable module 104 downward. In the illustrated embodiment, the actuation feature 508 includes a ramp surface to guide mating with the spring arm 164.

In an exemplary embodiment, the socket connector 200 is mounted directly to the host circuit board 110. The socket contacts 202 are terminated to the board contacts 111 of the host circuit board 110. For example, the socket contacts 202 may be soldered to the board contacts 111. In the illustrated embodiment, the socket connector 200 is located at the rear end of the cage 120, such as adjacent the rear wall 136. The walls 122 of the cage 120 guide loading of the pluggable module 104 into the module channel 124 to mate with the socket connector 200. In an exemplary embodiment, a lifter spring 190 is provided forward of the socket connector 200. The lifter spring 190 is used to lift the pluggable module 104 upward in the module channel 124, such as to reduce or eliminate wiping of the socket contacts 202 as the pluggable module 104 is loaded into the module channel 124. The spring force of the lifter spring 190 is overcome by the downward mating force of the spring latch 160 when the pluggable module 104 interfaces with the spring latch 160.

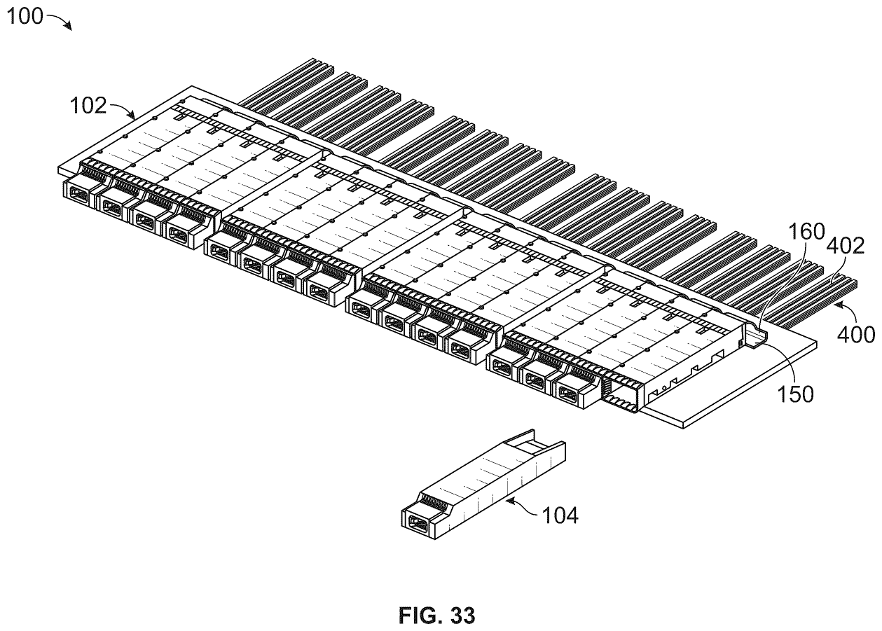

FIG. 33 is a front perspective view of the electrical connector system 100 formed in accordance with an exemplary embodiment. FIG. 33 illustrates the circuit card assembly 102 using the cable assembly 400 formed in accordance with an exemplary embodiment. The cables 402 of the cable assembly 400 are configured to be routed over the board (or under the board), rather then via traces or circuits of the host circuit board) to another component, such as the electrical device 106. The cables 402 allow high-speed data signaling between the pluggable module 104 and the electrical device 106 along shielded data communication lines. FIG. 33 illustrates the circuit card assembly 102 using the spring latch 160 as the loading mechanism 150; however, other types of loading mechanisms may be used in alternative embodiments.

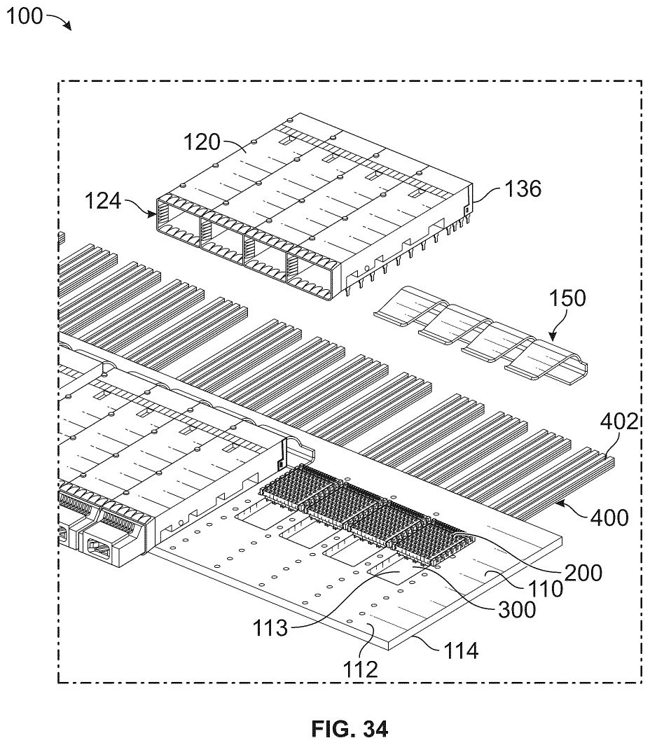

FIG. 34 is an exploded view of a portion of the electrical connector system 100 in accordance with an exemplary embodiment. FIG. 34 shows the host circuit board 110, the cage 120, the loading mechanism 150, the socket connector 200, and the interposer 300 in accordance with an exemplary embodiment.

In an exemplary embodiment, the host circuit board 110 includes openings 113 between the upper surface 112 and the lower surface 114. The openings 113 are located in the mounting areas where the cage 120 is mounted to the host circuit board 110. The openings 113 provide access to the module channel 124 from below the host circuit board 110. In an exemplary embodiment, the socket connector 200 and the interposer 300 are loaded into the module channel 124 through the opening 113. As such, the cable assembly 400 may be located below the host circuit board 110 such that the cables 402 may be routed along the lower surface 114 of the host circuit board 110. In alternative embodiments, the host circuit board 110 may be provided without the openings 113. Rather, the interposer 300 may be loaded into the module channel 124 through the rear wall 136 and the cables 402 may be routed from the cage 120 along the upper surface 112 of the host circuit board 110.

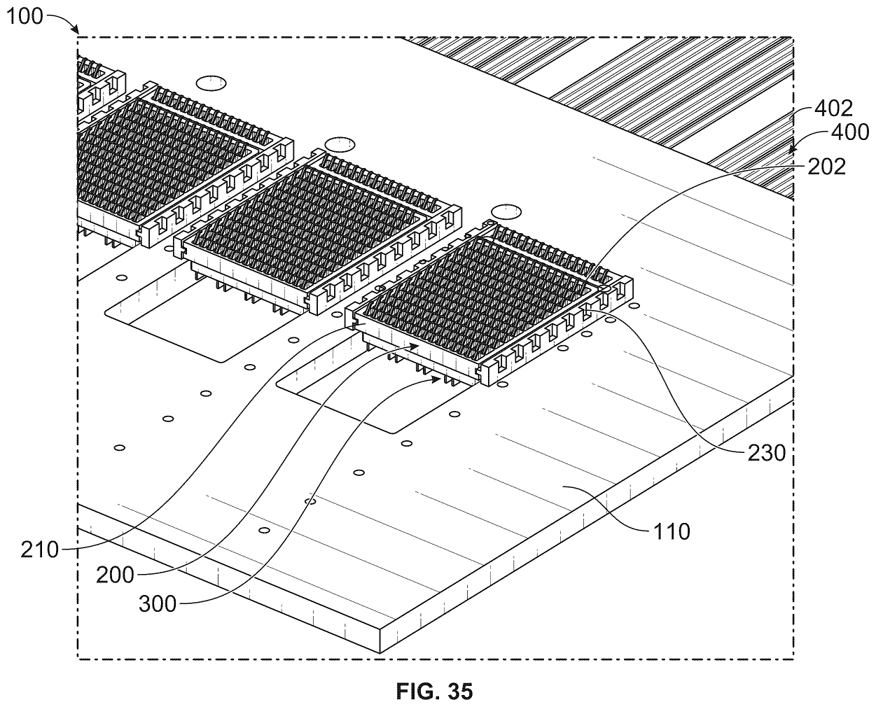

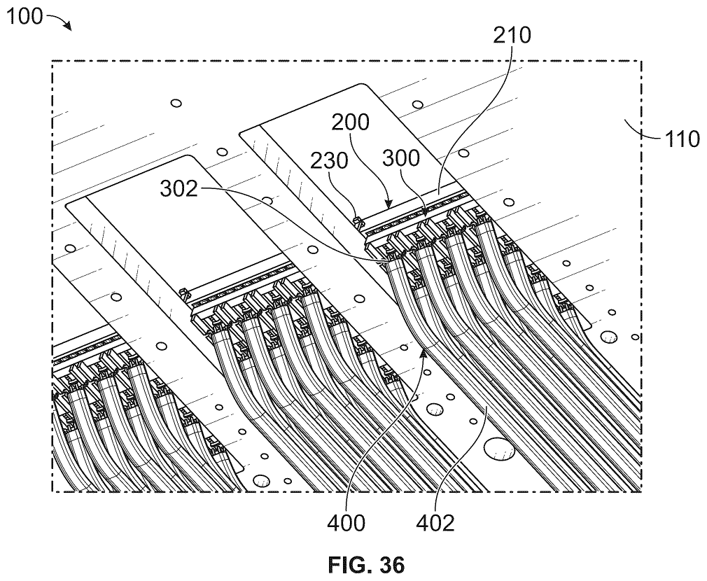

FIG. 35 is a top perspective view of a portion of the electrical connector system 100 showing the socket connector 200 and the interposer 300 coupled to the host circuit board 110. FIG. 36 is a bottom perspective view of a portion of the electrical connector system 100 showing the socket connector 200 and the interposer 300 coupled to the host circuit board 110.

The socket connector 200 includes the socket substrate 210 and the socket frame 230 holding the socket substrate 210. The socket substrate 210 holds the socket contacts 202 in a contact array. In the illustrated embodiment, the socket frame 230 includes a plurality of the contact channels that hold corresponding socket contacts 202. For example, the high speed signal array may be held by the socket substrate 210 while the low speed and power array may be held by the socket frame 230. The socket frame 230 is configured be mounted to the host circuit board 110. For example, the socket frame 230 may be mounted to the host circuit board 110 using solder tabs, compliant pins, or fasteners. The socket substrate 210 may be removably coupled to the socket frame 230 while the socket frame 230 remains mounted to the host circuit board 110.

The interposer 300 is coupled to the socket connector 200, such as to the socket substrate 210. The interposer 300 is used to electrically connect the cable assembly 400 to the socket connector 200. For example, the interposer contacts 302 electrically connect the cables 402 to the socket contacts 202. In an exemplary embodiment, the interposer 300 provides electrical shielding and a ground reference for the interposer contacts 302.

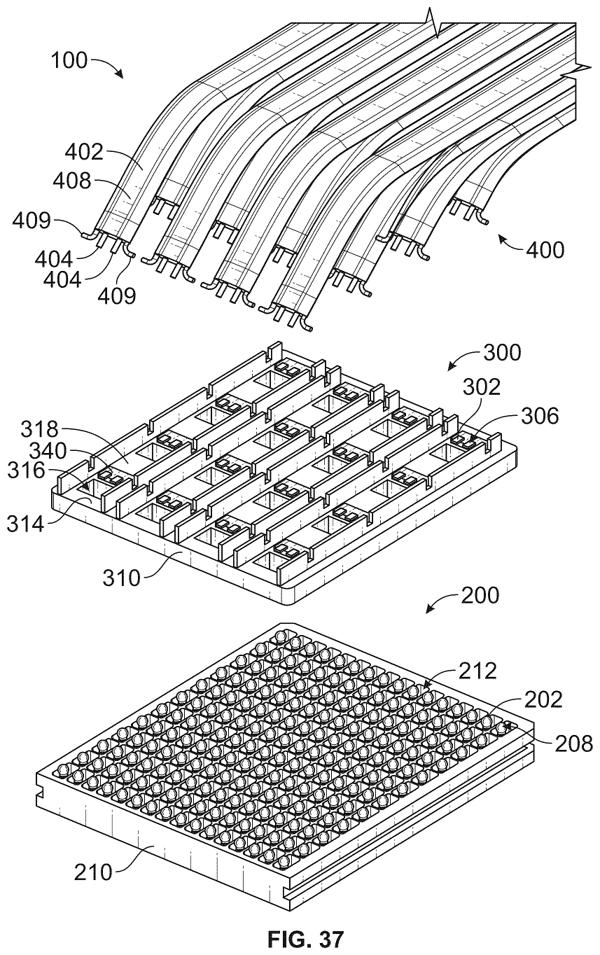

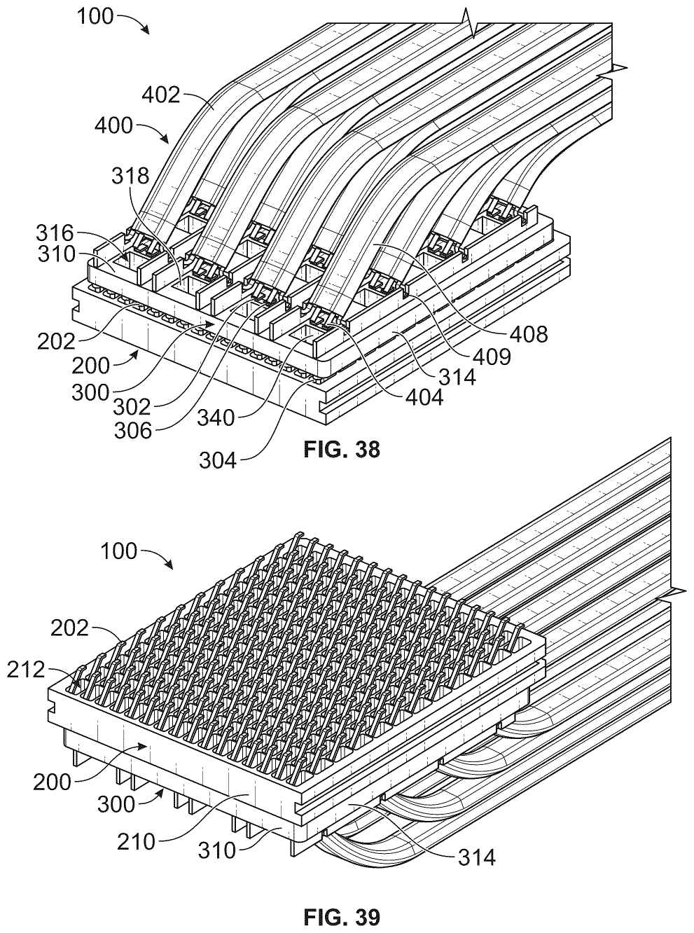

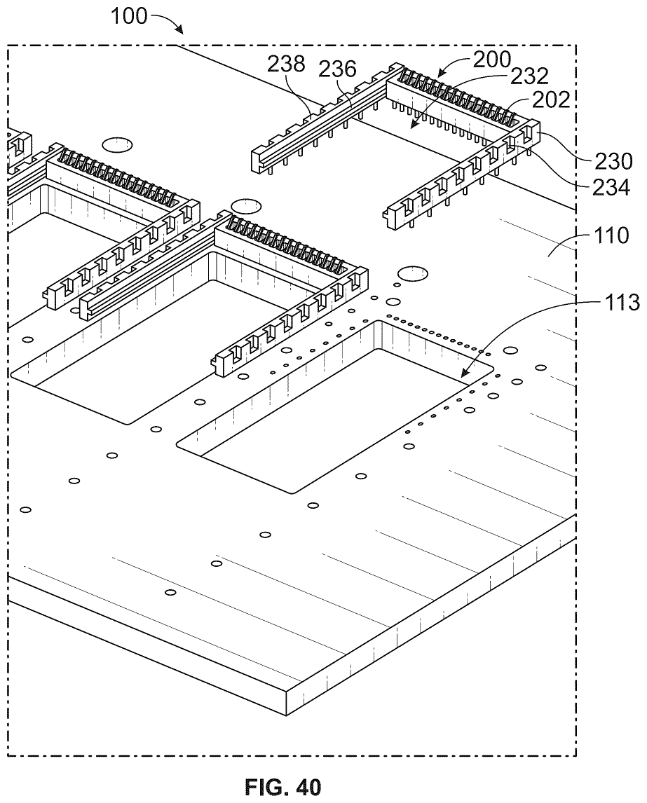

FIG. 37 is a bottom perspective, exploded view of a portion of the electrical connector system 100 in accordance with an exemplary embodiment showing the socket connector 200, the interposer 300, and the cable assembly 400. FIG. 38 is a bottom perspective, assembled view of a portion of the electrical connector system 100 in accordance with an exemplary embodiment showing the socket connector 200, the interposer 300, and the cable assembly 400. FIG. 39 is a top perspective, assembled view of a portion of the electrical connector system 100 in accordance with an exemplary embodiment showing the socket connector 200, the interposer 300, and the cable assembly 400.

The cable assembly 400 includes a plurality of the cables 402. In the illustrated embodiment, each cable 402 is a twinaxial cable. Each cable 402 includes a pair of the conductors 404 and the cable shield 408 that provide electrical shielding for the conductors 404. In various embodiments, the cable 402 may include one or more drain wires 409, which may be electrically connected to the interposer 300.

The socket connector 200 includes the socket substrate 210 holding the socket contacts 202. For example, the socket contacts 202 may be received in corresponding contact channels 212. In the illustrated embodiment, the socket contacts 202 include solder balls at the lower contacts 208 of the socket contacts 202. The solder balls are configured to be soldered to the corresponding interposer contacts 302.

The interposer 300 includes the interposer substrate 310 holding the interposer contacts 302. In the illustrated embodiment, the interposer substrate 310 includes a plate 314 having contact channels 316. The interposer substrate 310 includes walls 318 between the contact channels 316. In an exemplary embodiment, the interposer substrate 310 is electrically conductive to provide a shielding structure for the interposer contacts 302. For example, the interposer substrate 310 may be manufactured from a conductive polymer or a non-conductive polymer with a conductive plating or coating. In other embodiments, the interposer substrate 310 may be manufactured from a metal plate, such as an aluminum plate or die cast using a metal alloy. The cable shields 408 are configured to be electrically connected to the interposer substrate 310 to electrically common the cable shields 408 with the interposer substrate 310. For example, the drain wires 409 may be terminated to the interposer substrate 310.

In an exemplary embodiment, the interposer 300 includes contact holders 340 that hold the corresponding interposer contacts 302. The contact holders 340 is manufactured from a dielectric material, such as a plastic material. Optionally, the contact holders 340 may be overmolded over the interposer contacts 302. In the illustrated embodiment, each contact holder 340 holds a pair of the interposer contacts 302. However, each contact holder 340 may hold greater or fewer interposer contacts 302 in alternative embodiments. The contact holders 340 are received in corresponding contact channels 316 of the interposer substrate 310. The contact holders 340 isolate the interposer contacts 302 from the shield structure (for example, from the conductive interposer substrate 310). The interposer contacts 302 extend between the mating ends 304 and the terminating ends 306. The terminating ends 306 are configured to be terminated to the corresponding conductors 404 of the cables 402. For example, the conductors 404 may be soldered to the terminating ends 306. In other embodiments, the terminating ends 306 may include insulation displacement contacts, crimp barrels, or other terminating features for terminating to the conductors 404. The mating ends 304 are configured to be mated with the corresponding socket contacts 202. For example, the solder balls of the socket contacts 202 may be soldered to the mating ends 304 of the interposer contacts 302.

FIG. 40 is a top perspective, exploded view of a portion of the electrical connector system 100 in accordance with an exemplary embodiment. In an exemplary embodiment, the socket frame 230 of the socket connector 200 is mounted to the host circuit board 110 prior to connecting the socket substrate 210 to the socket frame 230. The socket frame 230 holds an array of the socket contacts 202, which may be used for low speed data signals and power. In an exemplary embodiment, the socket frame 230 includes a plurality of mounting pins 234 extending from the bottom of the socket frame 230 the mounting pins may be compliant pins, such as eye of the needle pins, configured to be press-fit into vias in the host circuit board 110. The socket frame 230 is mounted to the host circuit board 110 adjacent to the opening 113. In an exemplary embodiment, the socket frame 230 includes rails 236 extending along frame members 238 of the socket frame 230. The rails 236 extend into the socket cavity 232 and are configured to hold the socket substrate 210 in the socket cavity 232.

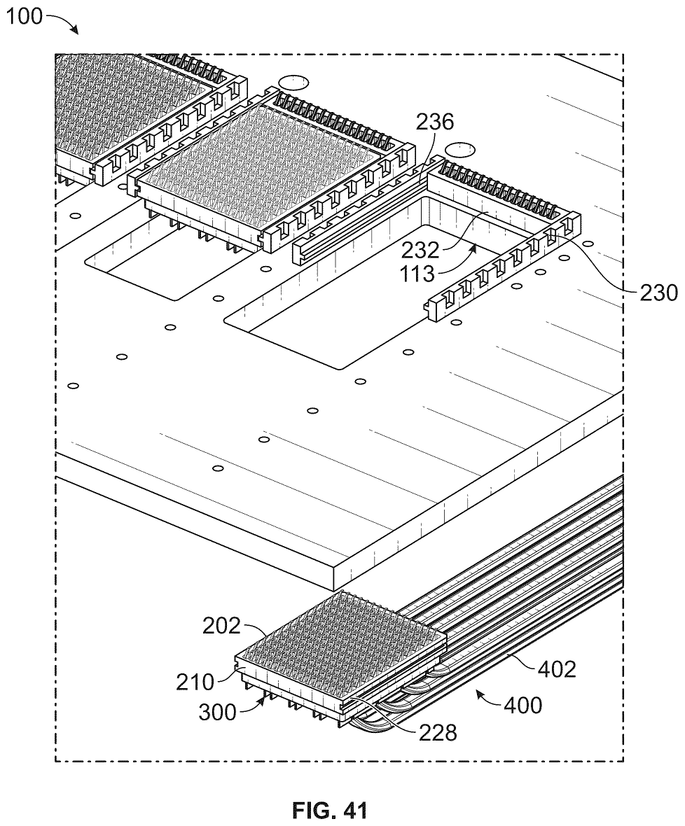

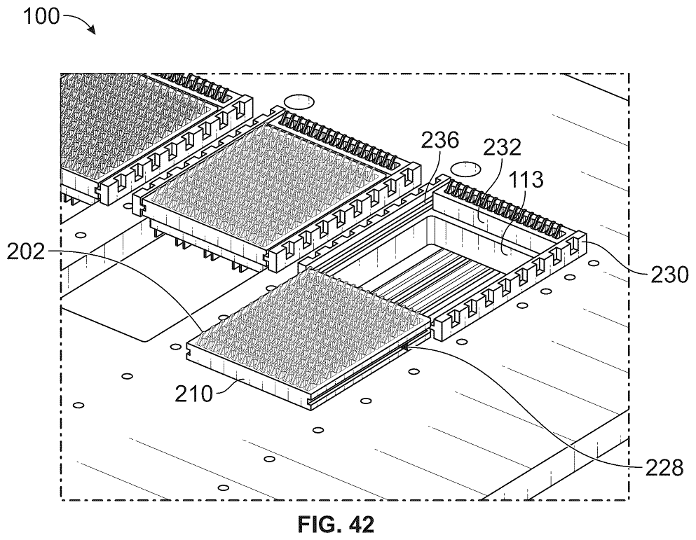

FIG. 41 is a top perspective, exploded view of a portion of the electrical connector system 100 in accordance with an exemplary embodiment showing the socket substrate 210 poised for mating with the socket frame 230. FIG. 42 is a top perspective, exploded view of a portion of the electrical connector system 100 in accordance with an exemplary embodiment showing the socket substrate 210 partially mated with the socket frame 230.

When assembled, the interposer 300 is coupled to the socket substrate 210. The interposer contacts 302 are electrically connected to the socket contacts 202. The cable assembly 400 is electrically connected to the interposer 300. The conductors 404 of the cables 402 are terminated to the interposer contacts 302. During assembly, the socket substrate 210 is loaded through the opening 113 and positioned to interface with the socket frame 230. The socket substrate 210 may be located forward of the socket frame 230 and is moved rearward to mate with the socket frame 230. In an exemplary embodiment, the socket substrate 210 includes channels 228 extending along the sides of the socket substrate 210. The channels 228 receive the rails 236 as the socket substrate 210 is loaded into the socket cavity 232 of the socket frame 230. When assembled, the socket frame 230 holds the socket substrate 210, the interposer 300, and the cable assembly 400 within the cage 120 (not shown) for mating with the pluggable module 104 (not shown).

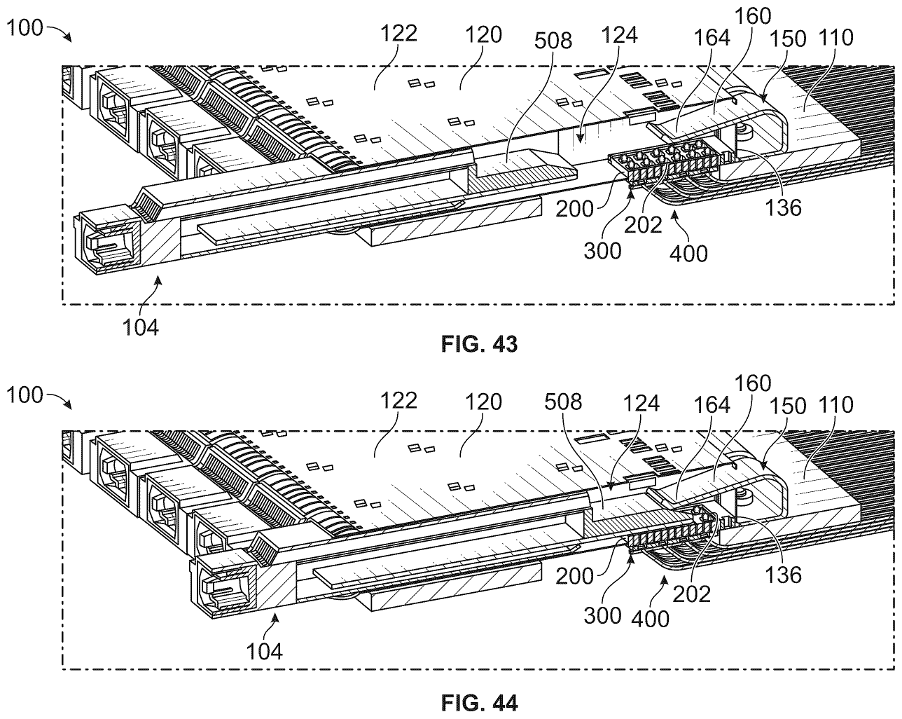

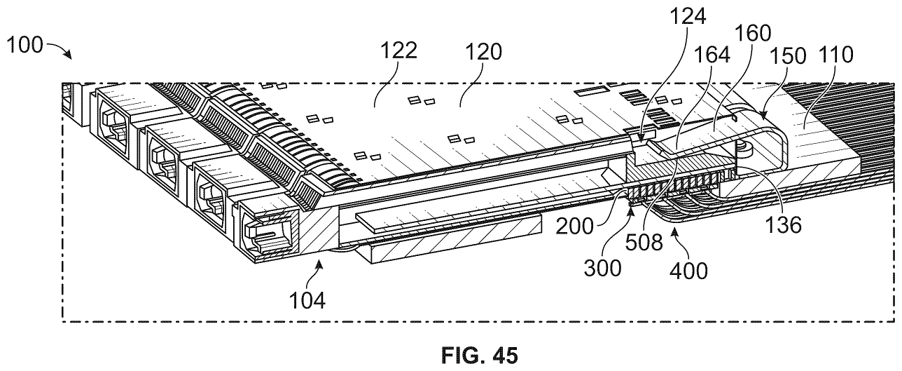

FIG. 43-45 illustrate a mating sequence of the electrical connector system 100 in accordance with an exemplary embodiment. FIG. 43 is a sectional view of the electrical connector system 100 showing the pluggable module 104 partially loaded into the cage 120. FIG. 44 is a sectional view of the electrical connector system 100 showing the pluggable module 104 partially loaded into the cage 120 and initially interfacing with the loading mechanism 150. FIG. 45 is a sectional view of the electrical connector system 100 showing the pluggable module 104 fully loaded into the cage 120 and mated with the socket connector 200. The pluggable module 104 is loaded into the cage 120 in a module loading direction (for example, horizontally). The loading mechanism 150 moves the pluggable module 104 in a contact mating direction (for example, vertically) that is transverse to the module loading direction. Optionally, the contact mating direction may be generally perpendicular to the module loading direction. The socket contacts 202 are compressed when the pluggable module 104 is moved in the contact mating direction to create a reliable electrical connection between the pluggable module 104 and the socket connector 200. The cables 402 of the cable assembly 400 are configured to be routed over the board (or under the board), rather than via traces or circuits of the host circuit board) to another component, such as the electrical device 106. The interposer 300 may be provided at the interface between the socket connector 200 and the cable assembly 400. The cables of the cable assembly 400 may be terminated directly to the socket connector 200 in various embodiments. The cables 402 allow high-speed data signaling between the pluggable module 104 and the electrical device 106 along shielded data communication lines.

In an exemplary embodiment, the spring latch 160 is mounted to the host circuit board 110 rearward of the cage 120. The spring arm 164 extends through an opening in the rear wall 136, or other wall 122, of the cage 120 into the module channel 124. The spring arm 164 is located above the socket connector 200. The spring arm 164 is configured to engage the pluggable module 104 to press the pluggable module 104 in a downward direction to mate the pluggable module 104 with the socket connector 200. The spring arm 164 presses the pluggable module 104 downward to compress the socket contacts 202. In an exemplary embodiment, the spring arm 164 engages the actuation feature 508 at the top of the pluggable module 104 to press the pluggable module 104 downward. In the illustrated embodiment, the actuation feature 508 includes a ramp surface to guide mating with the spring arm 164.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 200(f), unless and until such claim limitations expressly use the phrase “means for” followed by a statement of function void of further structure.

What is claimed is:

1. An electrical connector system comprising:
a circuit card assembly including a host circuit board, an interposer, and a socket connector arranged in a circuit stack, the interposer including interposer contacts, the interposer contacts having mating ends and terminating ends opposite the mating ends, the socket connector including socket contacts, the socket contacts being compressible, the socket contacts having first mating ends and second mating ends, the first mating ends having separable mating interfaces, the second mating ends having separable mating interfaces, the second mating ends being connected to the mating ends of the corresponding interposer contacts;
a cable assembly having cables electrically connected to corresponding terminating ends of the interposer contacts;
a pluggable module including a module body having a top and a bottom, the pluggable module having a mating end, the pluggable module including a module circuit board held by the module body at the mating end, the module circuit board having module contacts mated with the corresponding first mating ends of the socket contacts; and
a loading mechanism operably coupled to the circuit card assembly, the loading mechanism being operated to compress the socket contacts between the module circuit board and the interposer contacts to create circuit paths between the module contacts and the interposer contacts through the socket contacts;
wherein the cables are electrically connected to the pluggable module through the interposer and the socket connector.

2. The electrical connector system of claim 1, wherein the module circuit board is aligned with the circuit stack with the socket connector located between the module circuit board and the interposer.

3. The electrical connector system of claim 1, wherein the interposer includes an interposer circuit board, the interposer contacts being circuit traces of the interposer circuit board.

4. The electrical connector system of claim 4, wherein the cables are terminated to the interposer circuit board, the interposer circuit board electrically connecting the cables to the socket contacts.

5. The electrical connector system of claim 4, wherein the interposer circuit board includes an upper surface extending between a front and a rear, the mating ends of the interposer contacts defined by contact pads in an array on the upper surface at the front, the terminating ends of the interposer contacts defined by contact pads in an array on the upper surface at the rear.

6. The electrical connector system of claim 1, wherein the circuit card assembly includes a cage mounted to the circuit board, the cage having shielding walls forming a module channel with a port at a front of the cage to access the module channel, the mating end of the pluggable module being loaded into the module channel through the port and a module loading direction, the loading mechanism operably coupled to the pluggable module to force mating of the module contacts with the socket contacts in a contact mating direction transverse to the module loading direction.

7. The electrical connector system of claim 6, wherein the interposer is received in the module channel at a rear of the cage.

8. The electrical connector system of claim 6, wherein the loading mechanism is pivotably coupled to the cage.

9. The electrical connector system of claim 1, wherein the loading mechanism includes a latch movable between a released position and an actuated position, the latch pressing the pluggable module toward the socket connector when the latch is moved from the released position to the actuated position to compress the socket contacts.

10. The electrical connector system of claim 1, wherein the interposer includes a contact organizer holding the interposer contacts, the contact organizer located between the cables and the socket connector.

11. The electrical connector system of claim 1, wherein the cables are routed along an upper surface of the host circuit board.

12. The electrical connector system of claim 1, wherein the host circuit board includes an opening, the interposer received in the opening, the pluggable module located above the host circuit board, the cables located below the host circuit board.

13. An electrical connector system comprising:
a circuit card assembly including a host circuit board, an interposer, and a socket connector arranged in a circuit stack, the interposer including interposer contacts, the interposer contacts having mating ends and terminating ends opposite the mating ends, the socket connector including socket contacts, the socket contacts being compressible, the socket contacts having first mating ends and second mating ends, the first mating ends having separable mating interfaces, the second mating ends having separable mating interfaces, the second mating ends being connected to the mating ends of the corresponding interposer contacts;
a pluggable module including a module body having a top and a bottom, the pluggable module having a mating end, the pluggable module including a module circuit board held by the module body at the mating end, the module circuit board having module contacts mated with the corresponding first mating ends of the socket contacts; and
a loading mechanism operably coupled to the circuit card assembly, the loading mechanism being operated to compress the socket contacts between the module circuit board and the interposer contacts to create circuit paths between the module contacts and the interposer contacts through the socket contacts.

14. The electrical connector system of claim 13, further comprising a cable assembly having cables electrically connected to corresponding terminating ends of the interposer contacts, the cables being electrically connected to the socket connector through the interposer contacts.

15. The electrical connector system of claim 13, wherein the terminating ends of the interposer contacts are electrically connected to board contacts of the host circuit board, the socket contacts being electrically connected to the host circuit board through the interposer contacts.

16. The electrical connector system of claim 13, wherein the interposer includes an interposer circuit board, the interposer contacts being circuit traces of the interposer circuit board.

17. The electrical connector system of claim 13, wherein the interposer includes an interposer circuit board and an interposer housing holding the interposer circuit board, the socket connector being located between the interposer housing and the module body.

18. The electrical connector system of claim 13, wherein the circuit card assembly includes a cage mounted to the circuit board, the cage having shielding walls forming a module channel with a port at a front of the cage to access the module channel, the mating end of the pluggable module being loaded into the module channel through the port and a module loading direction, the loading mechanism operably coupled to the pluggable module to force mating of the module contacts with the socket contacts in a contact mating direction transverse to the module loading direction.

19. The electrical connector system of claim 13, wherein the circuit card assembly includes a cage mounted to the circuit board, the cage having shielding walls forming a module channel with a port at a front of the cage to access the module channel, the mating end of the pluggable module being loaded into the module channel through the port, the interposer being received in the module channel at a rear of the cage.

20. The electrical connector system of claim 13, wherein the loading mechanism includes a latch movable between a released position and an actuated position, the latch pressing the pluggable module toward the socket connector when the latch is moved from the released position to the actuated position to compress the socket contacts.

21. An electrical connector system comprising:
a circuit card assembly including a host circuit board, a cage mounted to the host circuit board, a socket connector received in the cage, and an interposer received in the cage, the cage having shielding walls forming a module channel extending between a front and a rear of the cage, the interposer including interposer contacts, the interposer contacts having mating ends and terminating ends opposite the mating ends, the socket connector including socket contacts, the socket contacts being compressible, the socket contacts having first mating ends and second mating ends, the first mating ends having separable mating interfaces, the second mating ends having separable mating interfaces, the second mating ends being connected to the mating ends of the corresponding interposer contacts;
a cable assembly having cables electrically connected to corresponding terminating ends of the interposer contacts;
a pluggable module including a module body having a top and a bottom, the pluggable module having a mating end, the mating end of the pluggable module being loaded into the module channel in a module loading direction, the pluggable module including a module circuit board held by the module body at the mating end, the module circuit board having module contacts mated with the corresponding first mating ends of the socket contacts, the pluggable module including an actuation feature associated with the module body; and
a loading mechanism operably coupled to the circuit card assembly, the loading mechanism engaging the actuation feature of the pluggable module to force mating of the module contacts with the first mating ends of the socket contacts in a contact mating direction transverse to the module loading direction to compress the socket contacts between the module circuit board and the interposer contacts and create circuit paths between the module contacts and the interposer contacts through the socket contacts;
wherein the cables are electrically connected to the pluggable module through the interposer and the socket connector.

22. An electrical connector system comprising:
a circuit card assembly including a host circuit board, a socket connector mounted to the host circuit board, and a cage mounted to the host circuit board, the socket connector having a socket substrate having an upper contact array of upper contacts and a lower contact array of lower contacts electrically connected to corresponding upper contacts, the upper contacts having separable mating interfaces being accessible from above the socket connector, the cage having shielding walls forming a module channel with a port at a front of the cage to access the module channel, the socket connector located in the module channel, the circuit card assembly including a loading mechanism located in the module channel; and
a pluggable module including a module body having a top and a bottom, the pluggable module having a mating end, the mating end of the pluggable module being loaded into the module channel through the port in a module loading direction, the module body having a window at the mating end along the bottom, the pluggable module including a module circuit board held by the module body at the mating end, the module circuit board having a module contact array of module contacts aligned with the window, the module contacts being exposed from below the module body for mating with corresponding upper contacts of the circuit card assembly, the pluggable module including an actuation feature associated with the module body engaging the loading mechanism of the circuit card assembly to force mating of the module contacts with the upper contacts of the circuit card assembly in a contact mating direction transverse to the module loading direction.
